(19) United States
(12) Patent Application Publication
(10) Pub. No.: US 2013/0038430 A1
(43) Pub. Date: Feb. 14, 2013

(54) BUILDING MANAGEMENT SYSTEM

(71) Applicants: Joseph Blower, Stockport, Cheshire (GB); Andrew Smith, Stockport Cheshire (GB); Tim Wright, Altrincham (GB)

(72) Inventors: Joseph Blower, Stockport, Cheshire (GB); Andrew Smith, Stockport Cheshire (GB); Tim Wright, Altrincham (GB)

(73) Assignee: Wireless Energy Management Systems Internatioal Limited, Stockport Cheshire (GB)

(21) Appl. No.: 13/582,704

(22) PCT Filed: Mar. 3, 2011
(86) PCT No.: PCT/EP2011/053238

§ 371 Date: Oct. 16, 2012

(30) Foreign Application Priority Data
Mar. 3, 2010 (GB) 1003524.4

(51) Int. Cl. G05B 11/01

(52) U.S. Cl. 340/12.22

(57) ABSTRACT

A building management system controller (10) is provided. The building management system controller may be configured to detect electro-magnetic interference on a plurality of frequency channels of a narrow band frequency, and select one of the plurality of frequency channels having a detected electro-magnetic interference which less than a predetermined electro-magnetic interference threshold as a communication channel for communicating with at least one device (12, 14). The building management system controller may also be configured to communicate wirelessly with at least one device (12, 14), to determine a communication reliability for communications between the controller and the at least one device, and to determine a communication route between the controller and the at least one device in dependence on the determined communication reliabilities. Devices 12, 14 together make up a network 8 of controllers/sensors for the building management system.

### FIELD

The present invention relates to a building management system. In particular, the present invention relates to a building management system (BMS) comprising a plurality of devices in wireless communication with a central BMS controller, the BMS controller being capable of determining a wavelength of communication and route of communication between each device and the BMS controller.

### BACKGROUND

A building management system (BMS) is a system which is installed in a building to monitor and control the building. Normally a BMS is a computer based system for controlling mechanical and electrical equipment within the building such as heating/cooling, lighting, power, fire and security systems. It is desirable to be able to access the BMS remotely. In most instances it is necessary for the BMS to monitor a situation, such as the temperature within the building, using sensors and then to take action in response to the sensed levels, such as activating/de-activating the heating system. In the case of a security system, the BMS may control access at turnstiles, close-circuit television and motion detectors. In the case of a fire alarm system, in the event of a fire, the BMS may activate the alarms, alert the emergency services, de-activate any elevators and close the ventilation system to stop the spread of smoke.

One function of building management systems which is becoming more important is monitoring and controlling a building's energy usage, so as to improve the efficiency of the building. For example, by de-activating lighting at pre-determined times (such as at weekends or in the evenings for an office building). In addition, as BMS's are becoming more complex, as more functions of a building are to be monitored and controlled, any inefficiencies in the control of the devices within the building results in energy wastage.

FIG. 1A illustrates schematically, a building management system of the prior art. The BMS of FIG. 1A comprises a plurality of devices 1A, 1B, which are in wired communication 5 with the BMS controller 2. The devices 1A are controller devices, which in most instances require a permanent connection to a power source (not illustrated), and the devices 1B are monitor/sensor devices, which in most instances do not require a permanent connection to a power source, e.g. they are battery powered. The BMS controller 2 is connected to the internet via a communications module 6, so that the BMS can be monitored remotely.

FIG. 1B illustrates schematically, another building management system of the prior art. The BMS of FIG. 1B is known as a hybrid BMS, since the BMS controller 2 is in wired communication 5 with the devices, 1A, 1B and is in wireless communication with the devices 4B. The devices 1A are controller devices, which in most instances require a permanent connection to a power source (not illustrated), and the devices 1B are monitor/sensor devices which in some instances require a permanent connection to a power source (not illustrated). The devices 4B are monitor/sensor devices, which in most instances do not require a permanent connection to a power source, e.g. they are battery powered.

In order to communicate wirelessly with the BMS controller 2, the plurality of devices 4B must communicate via a wireless module and a registry 3. The BMS controller 2 may then be connected to the internet via a communications module 6, so that the BMS can be monitored remotely.

The use of several wireless communication devices 4B reduces the wiring required within a building, providing easier installation. However, the innate structure of a building, comprising a plurality of internal walls over various floors, results in reduced signal strength from the wireless communication devices 4B to the BMS controller 2. In addition wireless communication devices 4B communicate using a pre-determined wavelength. However, this wavelength may be subject to interference from other systems within the building, which operate on the same or similar frequencies.

Another problem associated with building management systems is that in order to install such a system the installer must not only be a skilled programmer with knowledge of building management systems but must also have knowledge of the physical systems within a building such as plumbing systems, heating systems, fire alarm systems, etc. and how all these systems within a building relate to each other.

The aim of the invention is to provide a building management system which is easier to install than current systems. Another aim of the invention is to provide a building management system which is capable of utilising a plurality of wireless communication devices.

### SUMMARY

According to one embodiment of the invention, a building management system controller is provided. The building management system controller comprising: a wireless communication module configured to enable wireless communication with at least one device; a processor module configured to detect electro-magnetic interference on a plurality of frequency channels of a narrow band frequency, and select one of the plurality of frequency channels having a detected electro-magnetic interference which less than a predetermined electro-magnetic interference threshold as a communication channel for communicating with each of the at least one device; and a storage module for storing the selected communication channel.

According to another embodiment of the invention, the processor module is configured to periodically detect the electro-magnetic interference on each of the plurality of frequency channels, and store the periodically detected electro-magnetic interference in a second storage module.

According to another embodiment of the invention, the processor module is configured to retrieve the periodically detected electro-magnetic interference from the second storage module prior to selecting the communication channel.

According to another embodiment of the invention, the processor module is configured to detect the electro-magnetic interference on the plurality of frequency channels and select the communication channel whenever a device is added to the building management system.

According to another embodiment of the invention, if none of the plurality of frequency channels have a detected electro-magnetic interference which is less than the predetermined electro-magnetic interference threshold, then the processor module is configured to select the channel having the lowest detected electro-magnetic interference as the communication channel.

According to another embodiment of the invention, the processor module is configured to send a message to the each of the at least one device informing each device of the communication channel.

According to another embodiment of the invention, the processor module is configured to send a message, requesting a response, to each of the at least one device using the communication channel; and if one or more of the devices does not send the requested response using the communication channel, selecting the previous communication channel and sending a message, requesting a response, to the one or more devices using the previous communication channel.

According to another embodiment of the invention, any one of the plurality of frequency channels having a detected electro-magnetic interference which is less than the predetermined electro-magnetic interference threshold may be selected as the communication channel.

According to another embodiment of the invention, a frequency channel of the plurality of frequency channels having a detected electro-magnetic interference which is lower than a detected electro-magnetic interference of the plurality of other frequency channels is selected as the communication channel.

According to another embodiment of the invention, the building management system controller further comprises: a web interface module configured to enable a user to instruct the processor module to detect the electro-magnetic interference on the plurality of frequency channels, and select the communication channel.

According to another embodiment of the invention, the web interface module is configured to communicate information regarding each of the at least one device to a server and to receive information from the server.

According to another embodiment of the invention, each of the at least one device comprises a wired powered device or a non-wired powered device.

According to one embodiment of the invention, a building management system is provided. The building management system comprising: at least one device; and a controller configured to communicate wirelessly with each of the at least one device, to determine a communication reliability for communications between the controller and each of the at least one device, and to determine a communication route between the controller and each of the at least one device in dependence on the determined communication reliabilities.

According to another embodiment of the invention, the controller sends a communication, requesting a response, to each of the at least one device and determines the communication reliability between the controller and each of the at least one device following receipt of the requested response.

According to another embodiment of the invention, the controller stores the determined communication reliabilities between the controller and each of the at least one device in a storage module.

According to another embodiment of the invention, the controller determines the communication route in dependence on determined communication reliabilities which are above a predetermined communication reliability threshold.

According to another embodiment of the invention, the controller determines if any of the communication reliabilities are below the predetermined communication reliability threshold.

According to another embodiment of the invention, if any of the communication reliabilities are below the predetermined communication reliability threshold, then the controller sends a communication, requesting a response, to each of the at least one device having a communication reliability below the predetermined communication reliability threshold via one or more device having a communication reliability above the predetermined communication reliability threshold, and the controller determines a communication reliability for communications between the controller and each of the at least one device, via the one or more device, following receipt of the requested response.

According to another embodiment of the invention, the controller stores the communication reliability for communications between the controller and each of the at least one device, via the one or more device, in a storage module.

According to another embodiment of the invention, the one or more device comprises a wired powered device.

According to another embodiment of the invention, if none of the communication reliabilities are above the communication reliability threshold, then the controller is configured to determine the communication route in dependence on the highest determined communication reliability.

According to another embodiment of the invention, the controller sends a communication to each device using the determined communication route and informing each device of the communication route.

According to another embodiment of the invention, each device stores the communication route between the controller and the device in a storage module.

According to another embodiment of the invention, the controller stores the communication route between the controller and each device in a storage module.

According to another embodiment of the invention, each device is configured to send an acknowledgement to the controller using the determined communication route.

According to another embodiment of the invention, each device comprises a unique identifier, and wherein each device is configured to attach the unique identifier to the communication before transferring the message to the controller or to another device.

According to another embodiment of the invention, each device comprises a wired powered device or a non-wired powered device.

According to another embodiment of the invention, the controller comprises: a wireless communication module configured to enable wireless communication with each device; a processor module configured to detect electro-magnetic interference on a plurality of frequency channels of a narrow band frequency, and select one of the plurality of frequency channels having a detected electro-magnetic interference which less than a predetermined electro-magnetic interference threshold as a communication channel for communicating with each device; and a storage module for storing the selected communication channel.

According to another embodiment of the invention, the processor module is configured to periodically detect the electro-magnetic interference on each plurality of frequency channels, and store the periodically detected electro-magnetic interference in a second storage module.

According to another embodiment of the invention, the processor module is configured to retrieve the periodically detected electro-magnetic interference from the second storage module prior to selecting the communication channel.

According to another embodiment of the invention, the processor module is configured to detect the electro-magnetic interference on the plurality of frequency channels and select the communication channel whenever a device is added to the building management system.

According to another embodiment of the invention, if none of the plurality of frequency channels have a detected electro-magnetic interference which is less than the predetermined electro-magnetic interference threshold, then the processor module is configured to select the channel having the lowest detected electro-magnetic interference as the communication channel.

According to another embodiment of the invention, the processor module is configured to send a message to each device informing each device of the communication channel.

According to another embodiment of the invention, the processor module is configured to send a message, requesting a response, to each device using the communication channel; and if a device does not send the requested response using the communication channel, selecting the previous communication channel and sending a message, requesting a response, to the device using the previous communication channel.

According to another embodiment of the invention, any one of the plurality of frequency channels having a detected electro-magnetic interference which is less than the predetermined electro-magnetic interference threshold may be selected as the communication channel.

According to another embodiment of the invention, a frequency channel of the plurality of frequency channels having a detected electro-magnetic interference which is lower than a detected electro-magnetic interference of the plurality of other frequency channels is selected as the communication channel.

According to another embodiment of the invention, the building management system further comprises: a web interface module configured to enable a user to instruct the processor module to detect the electro-magnetic interference on the plurality of frequency channels, and select the communication channel.

According to another embodiment of the invention, the web interface module is configured to communicate information regarding each device to a server and to receive information from the server.

According to another embodiment of the invention, each device comprises a wired powered device or a non-wired powered device.

According to one embodiment of the invention, a method for selecting a communication channel for communication between a building management system controller and at least one device is provided. The method comprising the steps of: detecting electro-magnetic interference on a plurality of frequency channels of a narrow band frequency; selecting one of the plurality of frequency channels having a detected electro-magnetic interference which less than a predetermined electro-magnetic interference threshold as the communication channel; and storing the selected communication channel in a storage module.

According to another embodiment of the invention, the method further comprises: periodically detecting the electro-magnetic interference on the plurality of frequency channels; and storing the periodically detected electro-magnetic interference in a second storage module.

According to another embodiment of the invention, the method further comprises: retrieving the periodically detected electro-magnetic interference from the second storage module prior to selecting the communication channel.

4 According to another embodiment of the invention, the method further comprises: detecting the electro-magnetic interference on the plurality of frequency channels and selecting the communication channel whenever a device is added to the building management system.

According to another embodiment of the invention, the method further comprises: selecting as the communication channel the channel having the lowest detected electro-magnetic interference if none of the plurality of frequency channels have a detected electro-magnetic interference which is less than the predetermined electro-magnetic interference threshold.

According to another embodiment of the invention, the method further comprises: sending a message to each of the at least one device informing each device of the communication channel.

According to another embodiment of the invention, the method further comprises: sending a message, requesting a response, to each of the at least one device using the communication channel; and sending a message, requesting a response, to one or more of the at least one device using the previous communication channel, if the one or more of the at least one device does not send the requested response using the communication channel.

According to another embodiment of the invention, the method further comprises: selecting a frequency channel of the plurality of frequency channels having a detected electro-magnetic interference which is lower than a detected electro-magnetic interference of the plurality of other frequency channels as the communication channel.

According to one embodiment of the invention, a method for determining a wireless communication route between at least one device and a building management system controller is provided. The method comprising the steps of: determining a communication reliability for communications between the controller and each of the at least one device; and determining a communication route between the controller and each of the at least one device in dependence on the determined communication reliabilities.

According to another embodiment of the invention, the method further comprises: sending a communication, requesting a response, to each of the at least one device; and determining a communication reliability following receipt of the requested response.

According to another embodiment of the invention, the method further comprises: storing the determined communication reliabilities in a storage module.

According to another embodiment of the invention, the method further comprises: determining if any of the communication reliabilities are below a predetermined communication reliability threshold.

According to another embodiment of the invention, the method further comprises: sending a communication, requesting a response, to each of the at least one device having a communication reliability below the predetermined communication reliability threshold via one or more device having a communication reliability above the predetermined communication reliability threshold, and determining a communication reliability for communications between the controller and each of the at least one device, via the one or more device, following receipt of the requested response.

According to another embodiment of the invention, the method further comprises: storing the determined communication reliabilities for communications between the controller and each of the at least one device, via the one or more device, in a storage module.

According to another embodiment of the invention, the method further comprises: determining the communication route in dependence on determined communication reliabilities which are above a communication reliability threshold.

According to another embodiment of the invention, the method further comprises: sending a communication to each device using the determined communication route, informing each device of the communication route.

According to another embodiment of the invention, the method further comprises: storing at each device the communication route between the controller and the device.

According to another embodiment of the invention, the method further comprises: storing at the controller the communication route between the controller and the device.

According to another embodiment of the invention, the method further comprises: sending from each device an acknowledgement to the controller using the determined communication route.

According to another embodiment of the invention, the method further comprises: attaching an unique device identifier to the communication before sending the communication to the controller or to another device.

According to another embodiment of the invention, the method further comprises: detecting electro-magnetic interference on a plurality of frequency channels of a narrow band frequency; selecting one of the plurality of frequency channels having a detected electro-magnetic interference which less than a predetermined electro-magnetic interference threshold as the communication channel; and storing the selected communication channel in a storage module.

According to another embodiment of the invention, the method further comprises: periodically detecting the electro-magnetic interference on the plurality of frequency channels; and storing the periodically detected electro-magnetic interference in a second storage module.

According to another embodiment of the invention, the method further comprises: retrieving the periodically detected electro-magnetic interference from the second storage module prior to selecting the communication channel.

According to another embodiment of the invention, the method further comprises: detecting the electro-magnetic interference on the plurality of frequency channels and selecting the communication channel whenever a device is added to the building management system.

According to another embodiment of the invention, the method further comprises: selecting as the communication channel the channel having the lowest detected electro-magnetic interference if none of the plurality of frequency channels have a detected electro-magnetic interference which is less than the predetermined electro-magnetic interference threshold.

According to another embodiment of the invention, the method further comprises: sending a message to each of the at least one device informing each device of the communication channel.

According to another embodiment of the invention, the method further comprises: sending a message, requesting a response, to each of the at least one device using the communication channel; and sending a message, requesting a response, to one or more of the at least one device using the previous communication channel, if the one or more of the at least one device does not send the requested response using the communication channel.

According to another embodiment of the invention, the method further comprises: selecting a frequency channel of the plurality of frequency channels having a detected electro-magnetic interference which is lower than a detected electro-magnetic interference of the plurality of other frequency channels as the communication channel.

According to one embodiment of the invention, a building management system is provided. The building management system comprising: at least one wired powered device; at least one non-wired powered device; a controller configured to communicate wirelessly with the at least one wired powered device and the at least one non-wired powered device, and configured to communicate with a remote server; and an installation module comprising a storage device storing predetermined rules defining interrelations between wired powered devices and non-wired powered devices, and between wired powered devices and other wired powered devices, together with physical proximity rules; wherein upon addition of a new wired or non-wired powered device to the building management system, the installation module is configured to provide a user with a series of selectable options in dependence on the rules.

According to another embodiment of the invention, upon addition of the new wired or non-wired powered device to the building management system, the installation module is configured to require the user to select an input/output type of the new device.

According to another embodiment of the invention, upon addition of a new wired or non-wired powered device to the building management system, the installation module is configured to require the user to select whether any wired or non-wired powered device already belonging to the building management system are linked with the new device.

According to another embodiment of the invention, upon addition of a new wired or non-wired powered device to the building management system, the installation module is configured to require the user to select whether the new device is unique to a zone within the building management system.

According to another embodiment of the invention, the installation module is configured to enable to user to define a zone within the building management system.

According to another embodiment of the invention, upon addition of a new wired or non-wired powered device to the building management system, the installation module is configured to enable to user to select an existing zone.

According to another embodiment of the invention, zone comprises one or more of the rooms.

According to another embodiment of the invention, the installation module is configured to enable a user to define a floor plan of the building.

According to another embodiment of the invention, the installation module is configured to enable a user to select a layer of the building management system.

According to another embodiment of the invention, the building management system comprises a plurality of layers, and wherein the plurality of layers comprise at least one of: a heating layer; a lighting layer; a security layer.

According to another embodiment of the invention, the installation module is provided at the controller.

According to another embodiment of the invention, the installation module is provided at the server.

### DESCRIPTION OF THE DRAWINGS

For a better understanding of the invention and to show how the same may be carried into effect, reference will now be made by way of example to the accompanying drawings:

FIG. 1A illustrates schematically a building management system of the prior art;

FIG. 1B illustrates schematically a hybrid building management system of the prior art;

FIG. 2A illustrates schematically a building management system;

FIG. 2B illustrates schematically another building management system;

FIG. 3 illustrates schematically the main components of a building management system;

FIG. 4 illustrates schematically a building management system controller;

FIG. 5A illustrates schematically a process for determining a narrow band frequency channel for use in a building management system;

FIG. 5B illustrates schematically electro-magnetic interference detected for a plurality of channels within a narrow band frequency;

FIG. 6A illustrates schematically a communication connections between a BMS controller and a plurality of devices;

FIG. 6B illustrates a partial view of the communication connections of FIG. 6A;

FIGS. 6C to 6H illustrates exemplary storage tables storing determined communication reliabilities between each device illustrated in FIG. 6B and the controller 10;

FIG. 7 illustrates schematically a process for determining a communication route between a BMS controller and a plurality of devices;

FIG. 8A to 8I illustrates schematically storage tables;

FIG. 9 illustrates schematically a BMS controller;

FIG. 10 illustrates schematically a process flow diagram of the steps required to add a new heating device to a building management system;

FIG. 11 illustrates schematically a process flow diagram of the steps required to add a new lighting device to a building management system;

FIG. 12 illustrates schematically a building management system; and

FIG. 13 illustrates schematically another building management system.

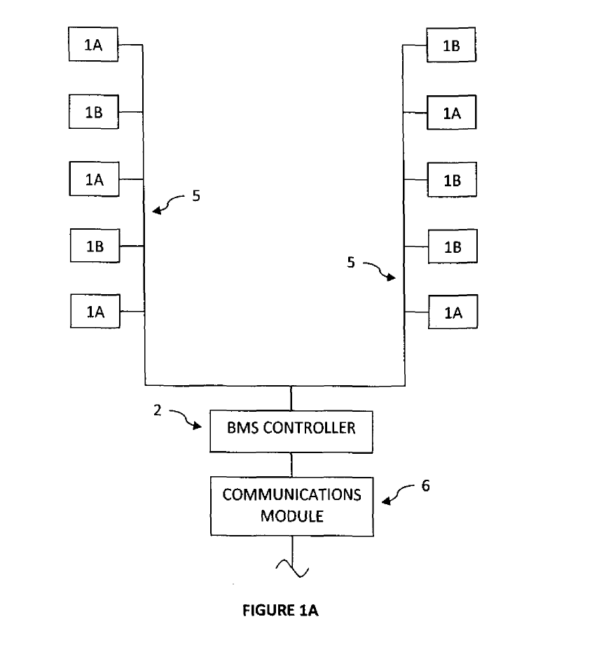

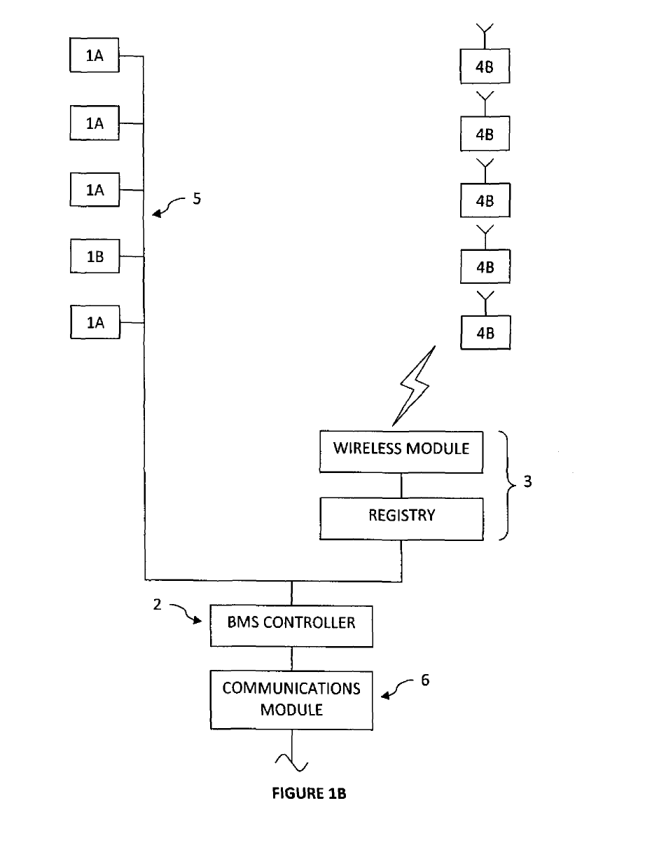

### DETAILED DESCRIPTION

Embodiments of the invention will now be described, by way of example only, with reference to the accompanying drawings.

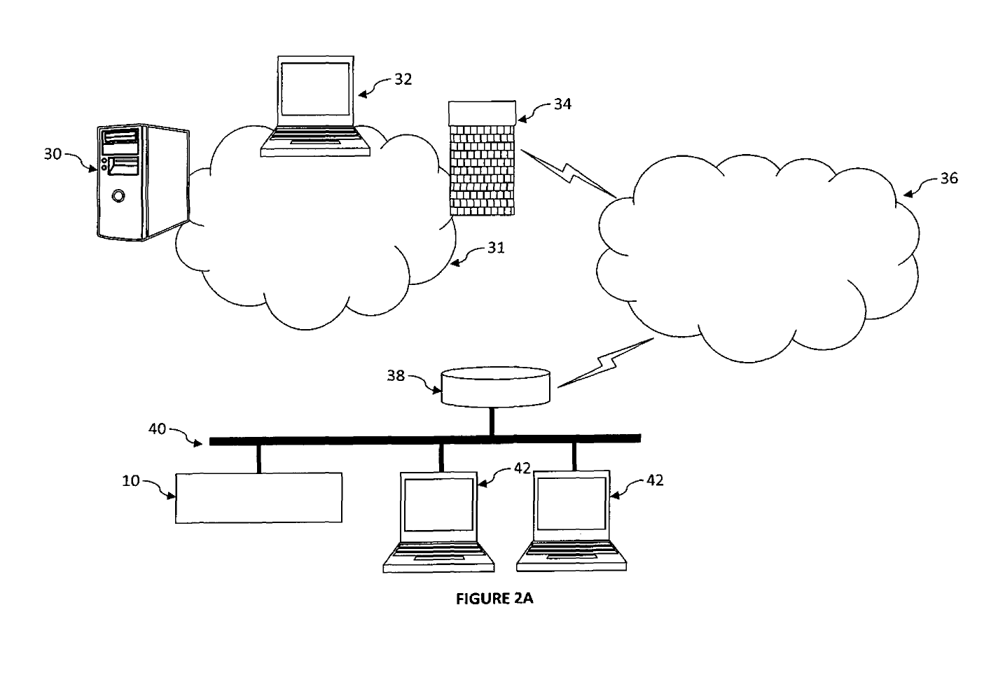

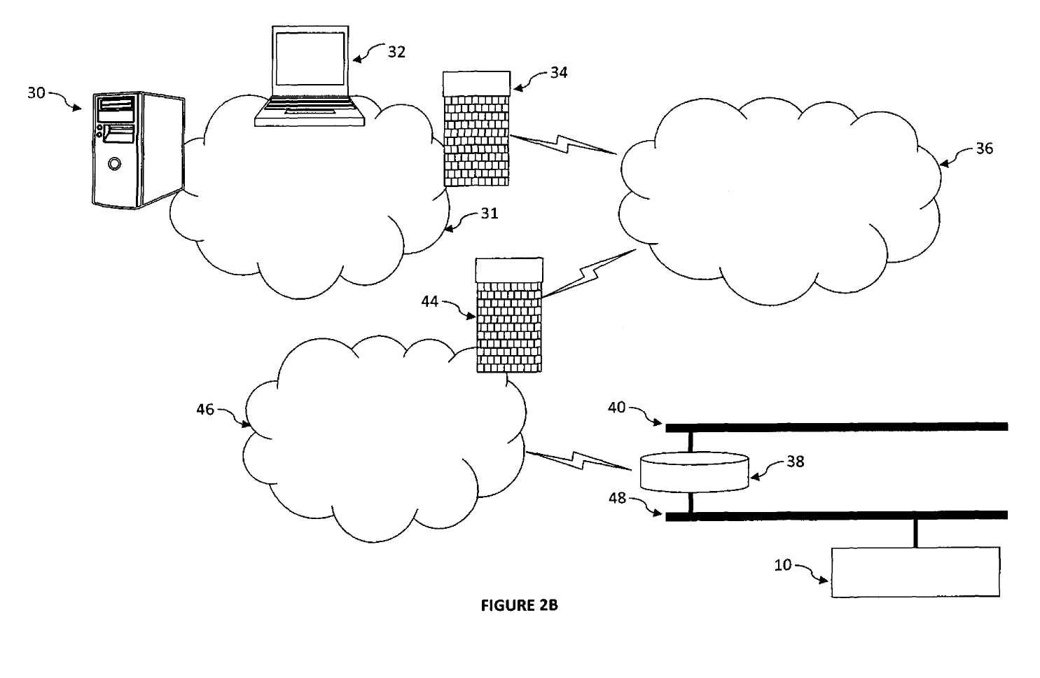

FIG. 2A illustrates an overview of a building management system. As can be seen from FIG. 2A, the building management system comprises a remote BMS network 31 comprising a server 30 which can be accessed via terminal 32. The server 30 communicates with a BMS controller 10 provided at the building which is being managed via the internet 36. In one embodiment a firewall 34 may be provided. A router 38 provided at the building is connected to the internet 36 and performs network address translation (NAT). The router 38, BMS controller 10 and terminals 42 are connected to a local area network (LAN) 40. The BMS controller 10 can be accessed either remotely at terminal 32, or locally at terminals 42. Consequently the building management system can be monitored either remotely or locally.

FIG. 2B illustrates an overview of a further building management system utilised when multiple sites (buildings) are being monitored. As can be seen from FIG. 2B, a corporate network 46 is provided with a firewall 44. In addition, a virtual LAN (VLAN) 48 is provided at the site. Although only one site is illustrated in FIG. 2B, a plurality of sites may be connected to the corporate network 46.

A virtual private network (VPN) connection may be used between the BMS network 31 and the corporate network 46, such that the server 30 and terminals 32 become nodes on the corporate network 46. The BMS is assigned a VLAN 48 within the corporate network 46 such that the BMS controller 10 at each site connects to the VLAN 48. The BMS controller 10 is thus isolated from the rest of the network at the site, which is connected to the LAN 40. Additionally, access control lists (ACLs) could be configured at the router 38 to restrict in/out bound traffic to/from the BMS controller 10 to only predetermined IP addresses and ports.

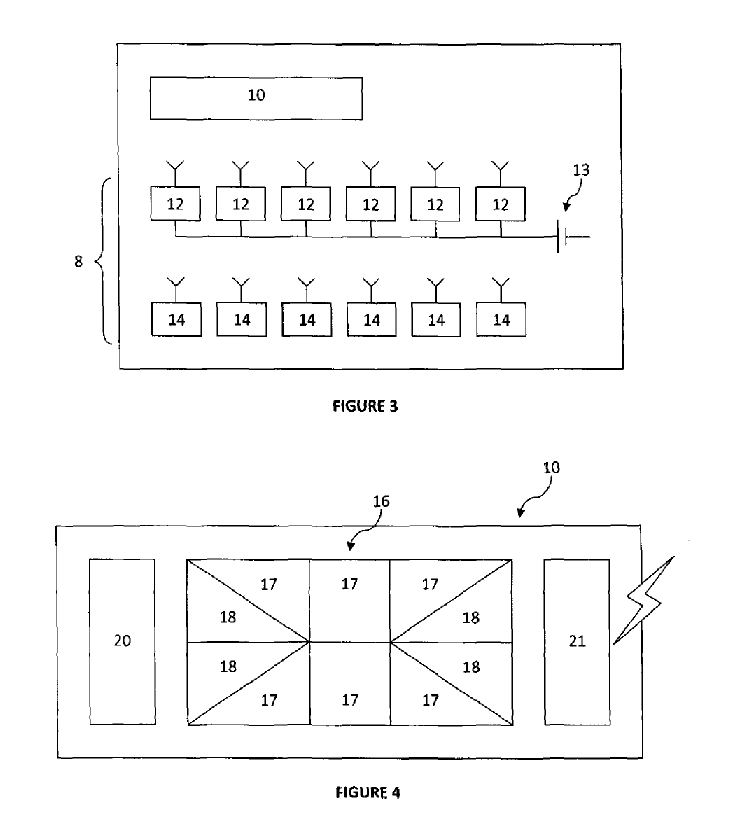

FIG. 3 illustrate schematically the components of a building management system to be provided at a site (building) to be managed. The BMS comprises a BMS controller 10, wired powered devices 12 connected (hardwired) to a power supply 13 such as mains power, and non-wired powered devices 14, the non-wired powered devices 14 obtain power from a power source such as a battery, or a solar cell etc. Both the wired and non-wired powered devices 12, 14 communicate wirelessly with the BMS controller 10.

In one embodiment, the wired powered devices 12 may be controller devices and the non-wired powered devices 14 may be sensor/monitor devices. Examples of sensor/monitor devices are light sensors, temperature sensors, carbon dioxide sensors, smoke sensors etc. These sensor devices 14 are predominantly passive and are asleep for most of the time. The sensor devices 14 only require power when a change is sensed, and thus are typically non-wired powered devices 14. Examples, of controller devices are controllers for turning on/off an air-conditioning system, controllers for turning on/off lights, controllers for adjusting valves etc. These controller devices 12 tend to requires a constant power supply, and thus are typically wired powered device 12. However, the controller devices may be wired or non-wired powered devices as required, and the sensor devices may be wired or non-wired powered devices as required. In addition, the wired powered devices 12 may be devices capable of controlling and sensing.

The different types and ranges of controller devices and sensor/monitor devices are well known in the field of building management systems and are not described in further detail herein.

The devices 12, 14 together make up a network 8 of controllers/sensors for the building management system.

FIG. 4 illustrates schematically the BMS controller 10. The BMS controller 10 comprises a web interface module 20, a wireless communication module 21, and a processor module 16. The web interface module 20 interfaces with the internet 36. The web interface module 20 is capable of communicating information regarding the devices 12, 14 to the server 30 at the BSM network 31, and receiving information from the server 30 at the BSM network 31. The wireless communication module 21 is capable of communicating wirelessly with the wired powered devices 12 and the non-wired powered devices 14.

The processor module 16 comprises a plurality of storage devices 17 and a plurality of agent devices 18. In one embodiment, the storage devices 17 store data as tables or as records of information. The data may be information received from the sensor/monitor devices 12, 14 as well as information which is provided by a user, such as a predetermined temperature at which the building is to be maintained. The agent devices 18 are capable of processing the data in the storage devices 17 and providing control signals to the controller devices 12, 14 as a result of analysis of the data in the storage devices 17. For example, a temperature reading of 25° C. may be received, via the wireless communication module 21, from a sensor/monitor device 12, 14, the predetermined temperature at which the building should be maintained, stored in one of the storage devices 17, may be 22° C. Consequently, one of the agent devices 18 would process the received and stored data, determine that the building is too hot and send a signal, via the wireless communication module 21, to a controller device 12, 14 to activate the air conditioning unit.

The BMS controller 10 also comprises a RF (radio frequency) module (not illustrated) which enables the BMS controller 10 to select a narrow band wavelength for communication between the wireless communication device 21 with the devices 12, 14 within the building. The RF module may be controlled by one of the agent devices 18.

In one embodiment the BMS controller 10 may support communication on ISM (Industrial, Scientific, Medical) bands. The ISM bands may allow communication over the frequencies 433.050 to 434.079 MHz 25 kHz (narrow band), 868 to 870 MHz 25 kHz (narrow band), and 902 to 928 MHz 25 kHz (narrow band). The use of 25 kHz narrow band reduces the signal to noise ratio (SNR) increasing the range the signal can be communicated over and increasing the signals immunity to noise. The narrow band range 433.050 to 434.079 MHz has 69 frequency channels available which may be used for narrow band communication. The narrow band range 868 to 870 MHz has 80 frequency channels available which may be used for narrow band communication. The narrow band range 902 to 928 MHz has 51 frequency channels available which may be used for narrow band communication. Within these frequency ranges the devices 12, 14 are capable of transmitting a signal up to 2 Km line of sight. However, this communication range may be reduced as a result of the structure of the building in which the BMS is provided. The use of a narrow band frequency increases the communication range of the devices 12, 14.

The term narrow band is a term of art and is not precisely limited to the specific narrow band frequencies provided.

The narrow band frequency over which the devices 12, 14 communicate within each building can be selected by the BMS controller 10 upon set-up of the BMS, and periodically if required. The narrow band frequency is selected to optimise the communication range of each device.

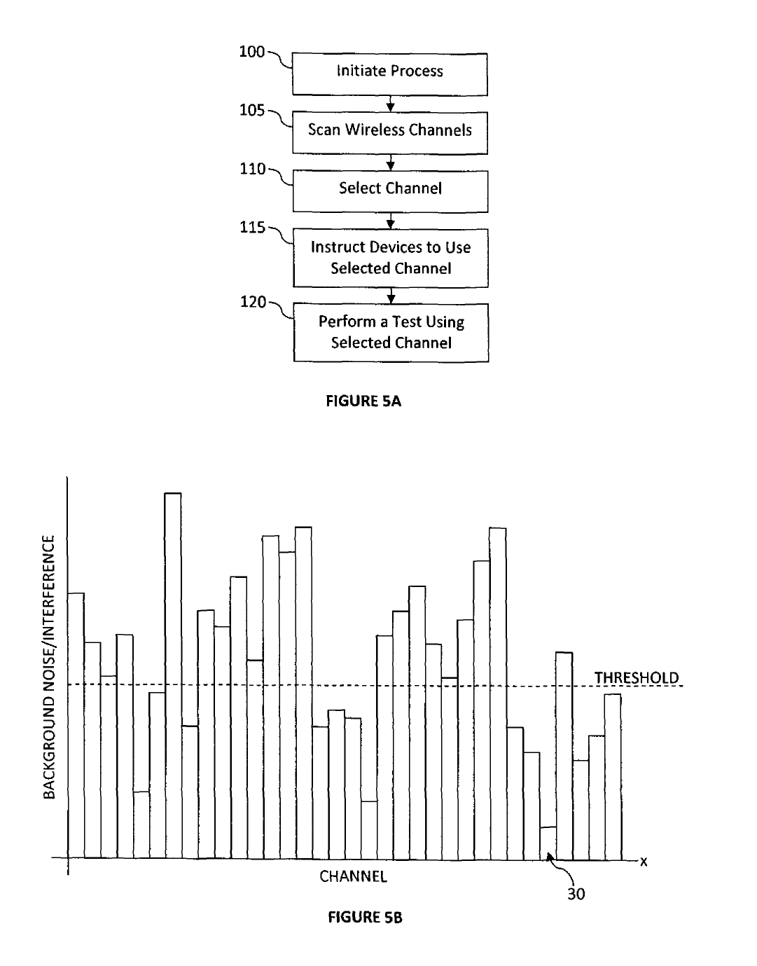

Upon set up of the building management system, the BMS controller 10 provided with data regarding all of the devices 12, 14 which form part of the building management system. For example, the BMS controller 10 may be provided with the unique identifier associated with each device 12, 14 and the type of each device 12, 14, i.e. whether each device is a sensor or a controller etc. Once the BMS controller 10 and the devices 12, 14 have been provided in situ in a building, the BMS controller 10 initiates a frequency selection process in order to select a narrow band communication frequency for the BMS. The narrow band frequency selected for each building may vary from building to building based on the geographical structure of the building and the networks and devices within the building, as well as near the building. Therefore the process of FIG. 5A may be completed in order to determine the optimum frequency to be used within each building.

FIG. 5A illustrates schematically a narrow band frequency channel selection process for use within a building. This narrow band frequency selection process can be used for any of the ISM bands mentioned above, or for any other narrow band frequency. As illustrated in FIG. 5A, the narrow band frequency selection process is imitated at step 100, in one embodiment by a user. The frequency channels of the narrow band frequency are then scanned at step 105 and a record of the electro-magnetic interference (EMI) detected on each channel is made.

Electro-magnetic interference is considered to be anything which alters, modifies, or disrupts a signal as it travels along a channel between the controller and the devices 12,14.

In one embodiment, each channel of the narrow band frequency is sampled 1000 time and an average of the detected EMI on each channel is determined. In one embodiment, the first channel may be sampled 100 times, followed by the second channel being sampled 100 times, etc. until all the channels have been sampled. The process then returns to the first channels and samples it another 100 times etc. This is repeated 10 times so that 1000 samples are obtained for each channel of the narrow band frequency.

FIG. 5B illustrates schematically a representation of the EMI detected at step 105, for a plurality of channels within a narrow band frequency.

If the narrow band being tested was 868 to 870 MHz then there would be 80 channels illustrated along the x axis of FIG. 5B. If the narrow band being tested was 902 to 928 MHz then there would be 51 channels illustrated along the x axis of FIG. 5B etc. If the narrow band being tested was 433.050 to 434.079 MHz then there would be 69 channels illustrated along the x axis of FIG. 5B etc.

As can be seen from FIG. 5B, the EMI detected on each channel varies from channel to channel. In one embodiment, the EMI detected on each channel illustrated in FIG. 5B is an average of the EMI detected for each channel. FIG. 5B also illustrates a threshold level.

The threshold indicates a maximum level of EMI which will be tolerated on the communication channel of the building management system. In one embodiment, the threshold may be set by a user/installer of the building management system. In one embodiment, the threshold may be set based on the selectivity of the devices 12, 14 which are to be used in the BMS

At step 110 of FIG. 5A, one of the channels having a EMI less than the threshold is selected as the communication channel for the building management system. With reference to FIG. 5B, the channel numbered 30 is selected as the communication channel because channel 30 has a detected EMI which is less than the threshold. In addition, the channel 30 has a detected EMI which is less than the EMI detected on the other channels of the narrow band frequency, which have a detected EMI which is less than the threshold. However, any of the channels having detected EMI which is less than the threshold may be selected as the communication channel for the building management system.

The threshold level indicates a level below which it is desirable for the EMI to be. However, if none of the channels have a detected EMI which is less than the threshold, then the channel having the smallest detected EMI is selected as the communication channel. The communication channel selected for each building management system is selected in order to optimise the communication range of the system.

Referring again to FIG. 5A, following selection of the communication channel, the BMS controller 10 sends a communication to each device 12, 14 of the building management system informing each device 12, 14 of the selected communication channel at step 115, and instructing each device to use the selected communication channel. The communication sent at step 115 is sent using the existing communication channel, or a default communication channel upon first use, if no other channel has been selected by the user/installer. The message sent at step 115 requests each device to send an acknowledgement back to the BMS using the existing/default communication channel. The devices 12, 14 then switch to the selected communication channel.

At step 120 a test of the building management system is performed using the selected communication channel. For example, a test signal could be sent from the BMS controller 10 to each device 12, 14 of the building management system requesting a response, the test signal being sent using the selected communication channel. If any the devices 12, 14 of the building management system do not respond using the selected communication channel, then the BMS controller 10 sends another signal using the previous channel, requesting the device(s) 12, 14 uses the selected channel. The controller 10 continues to switch between the previous communication channel and the selected communication channel sending messages to the unresponsive device(s) 12, 14 until an acknowledgment and successful test has been achieved.

In one embodiment, the wireless channels are scanned periodically, such that historical data regarding the EMI detected on each channel can be built up. The data may be stored in one of the storage devices 17. The historical data may then be analysed periodically in order to ascertain whether the communication channel should be changed. If a new communication channel is selected, then the process of FIG. 5A, steps 115 and 120 can be utilised in order to inform the devices 12, 14 of the system of the new communication channel.

In one embodiment, the process of FIG. 5A may be performed whenever a new device 12, 14 is added and/or removed from the building management system, and/or when updates are performed to the building, for example when a new wireless LAN or air-conditioning system etc. is fitted.

The selected communication channel is stored, in one embodiment, in one of the storage devices 17 of the BMS controller 10. In addition, the selected communication channel is stored, in one embodiment, at a storage module (not illustrated) of each of the devices 12, 14.

A user of the building management system may initiate the process of FIG. 5A for example, using a terminal 32 at the BMS network 31, or using a terminal 42 at the building.

As known in the art, a signals range is affected by obstacles and interference. For example, a signal can travel greater distances when there are no obstacles, such as from walls within a building, and/or no EMI. As it is unlikely that the BMS controller 10 will be provided at a position within a building such that all of the devices 12, 14 are within communication range as a result of obstacles and interference, the building management system uses the wired powered devices 12 to transfer data packets from wired powered devices 12, 14 and from non-wired powered devices 12, 14 which are not within communication range of the BMS controller 10, to the BMS controller 10.

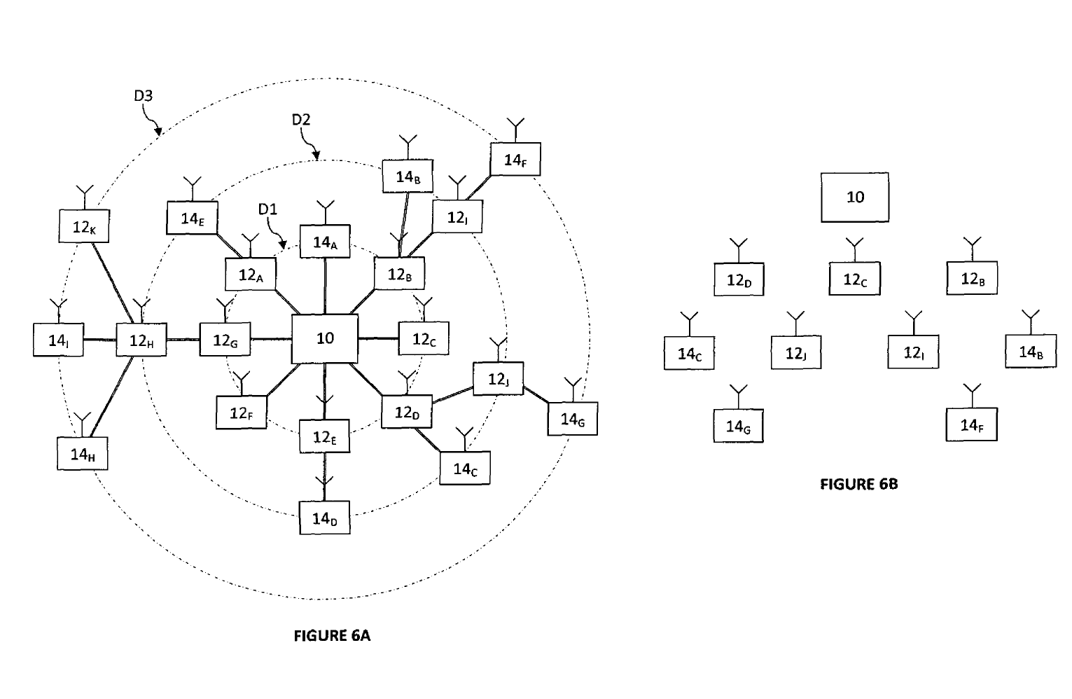

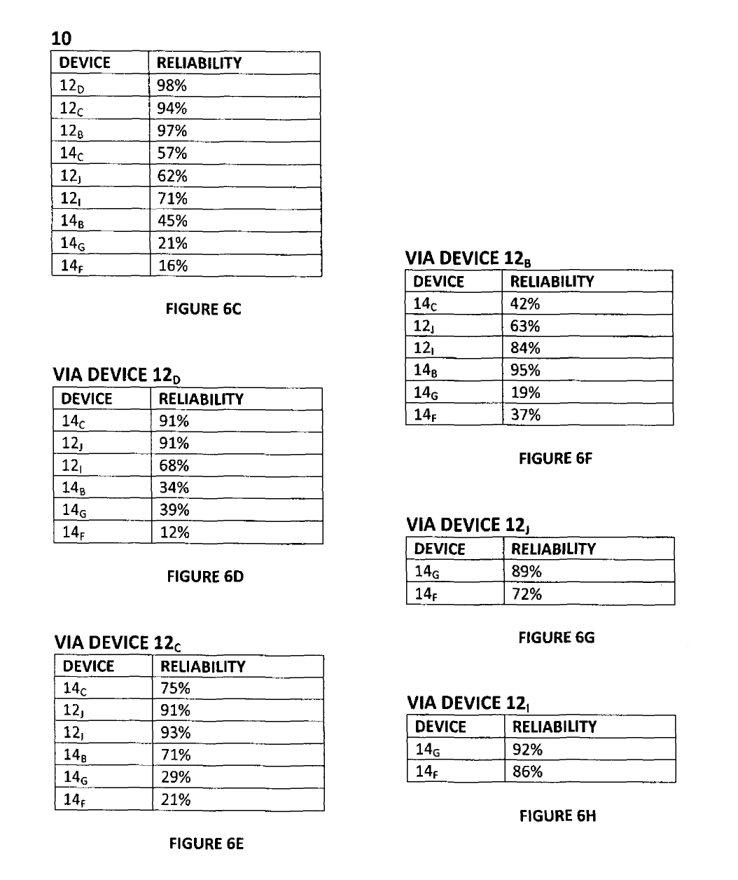

FIG. 6A illustrates schematically a wireless communication topology of a building management system network 8. Each of the devices 12, 14 are required to communicate with the BMS controller 10. In FIG. 6A the connecting lines between the devices 12, 14 and the BMS controller 10 illustrate wireless communication links not hardwired power connections or hardwired communication connections.

As illustrated schematically in FIG. 6A, the devices 12_{A}, 12_{B}, 12_{C}, 12_{D}, 12_{E}, 12_{F}, 12_{G}, and 14_{A} within communication range D1 of the BMS controller 10 are all able to communicate directly with the BMS controller 10. In one embodiment communication range D1 is 200 m from the BMS controller 10. However, the devices do not all have to be the same distance from the controller to be within the same communication range from the controller. The devices 12_{H}, 12_{I}, 12_{J}, 12_{K}, 14_{B}, 14_{C}, 14_{D}, 14_{E}, 14_{F}, 14_{G}, 14_{H} and 14_{I} situated at communication ranges D2 and D3 which are not within direct communication range of the BMS controller 10. The communication range is not limited to horizontal range, and communications may also be routed up and down between floors as well as on the same floor.

The devices 12_{H}, 12_{I}, 12_{J}, 14_{B}, 14_{C}, 14_{D}, and 14_{E} situated at communication range D2 from the BMS controller 10 are within communication range of the devices 12_{A}, 12_{B}, 12_{C}, 12_{D}, 12_{E}, 12_{F}, 12_{G}, and 14_{A}, which are within communication range D1 of the BMS controller 10, and thus within direct communication range of the BMS controller 10. The devices 14_{F}, 14_{G}, 14_{H}, 14_{I}, and 12_{K} situated at communication range D3 from the BMS controller 10 are within communication range of the devices 12_{H}, 12_{I}, 12_{J}, 14_{B}, 14_{C}, 14_{D}, and 14_{E} situated at communication range D2 from the BMS controller 10.

In order for the devices 12_{H}, 12_{I}, 12_{J}, 14_{B}, 14_{C}, 14_{D}, and 14_{E} situated at communication range D2 from the BMS controller 10 to communicate with the BMS controller 10, the data packets from these devices are transferred (hopped) via wired powered devices 12 within direct communication range (in this example, communication range D1) from the BMS controller 10. For example, for non-wired powered device 14_{B} to communicate with the BMS controller 10 its data packets are transmitted to wired powered device 12_{B} and then transmitted from wired powered device 12_{B} to the BMS controller 10, rather than going direct from non-wired powered device 14_{B} to the BMS controller 10, since the non-wired powered device 14_{B} is not within direct communication range of the BMS controller 10. The wired powered device 12_{B} merely relays the data packets from non-wired powered device 14_{B} to the BMS controller 10. In addition, if the controller 10 wishes to send a communication to the non-wired powered device 14_{B}, then it is sent via the wired powered device 12_{B}. Each data packet may be provided with an address bit which indicates that controller 10/the non-wired powered device 14_{B} is the intended recipient.

In addition, in order for the devices 14_{F}, 14_{G}, 14_{H}, 14_{I} and 12_{K} situated at communication range D3 from the BMS controller 10 to communicate with the BMS controller 10, the data packets from these devices are transferred (hopped) via wired powered devices 12 at communication ranges D2 and D1 from the BMS controller 10. For example, a data packet from a non-wired powered device such as device 14_{G} is transmitted to the wired powered device 12_{J}, from the wired powered device 12_{J} to the wired power device 12_{D}, and from the wired power device 12_{D} to the BMS controller 10. The wired power devices 12_{J} and 12_{D} merely relays the data packets to the BMS controller 10. In addition, if the BMS controller 10 wishes to send a communication to the wired power device 14_{G}, then it is sent via the wired powered devices 12_{D} and 12_{J}. In another example, a data packet from a wired powered device such as device 12_{K} is transmitted to the wired powered device 12_{H}, from the wired powered device 12_{H} to the wired power device 12_{G}, and from the wired power device 12_{G} to the BMS controller 10. Again, the wired power devices 12_{H} and 12_{G} merely relay the data packets to the BMS controller 10. In addition, if the BMS controller 10 wishes to send a communication to the wired power device 12_{K}, then it is sent via the wired powered devices 12_{H} and 12_{G}. Therefore, data packets to/from non-wired powered devices 14 and to/from wired power devices 12 are transferred via other wired power devices 12 from/to the BMS controller 10.

Communication ranges D2 and D3 are outside the direct communication range (communication range D1) of the BMS controller 10, and thus any devices 12, 14 provided within communication ranges D2 and D3 and outside of the direct communication range of the BMS controller 10 and cannot communicate directly with the BMS controller 10.

Each data packet may contain an indication of the source device, the destination device and the route which the packet is to take (i.e. whether the packet is to be relayed by device(s) 12). The wired power devices 12 which relay the data packets to/from the BMS controller 10, set a flag within the packet to indicate that the packet has been sent via the required device(s) 12. However, the wired power devices 12 which relay the data packets do not substantially alter the message.

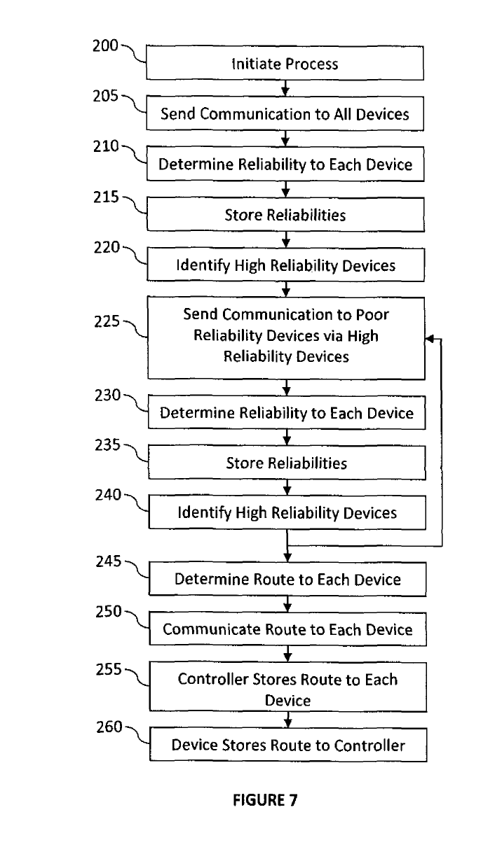

In order to determine a communication route from the controller 10 to each of the devices 12, 14 and from each of the devices 12, 14 to the controller 10, the process illustrated in FIG. 7 may be utilised. The process is initiated at step 200. At step 205 the controller 10 sends a communication directly to each device 12, 14 in the system requesting a response. In one embodiment, the controller sends 100 data packets to each device 12, 14 in the system, each packet requesting a response. At step 210 the controller 10 determines a reliability for communicating directly with each device 12, 14. In the above example, the communication reliability is determined based on the number of responses received from each device, for example, if the controller sent 100 packets to a device and receives 87 packets back from the device, then the communication reliability to that device is determined to be 87%. The controller 10 stores the determined communication reliability to each device at step 215. In one example the determined communication reliabilities between each device and the controller 10 are stored in a table at a storage device 17.

The further steps of the process illustrated in FIG. 7 will now be described with references to FIGS. 6B to 6H. FIG. 6B illustrates only some of the devices illustrated in FIG. 6A for ease of explanation, and the tables illustrated in FIGS. 6C to 6H detail the determined communication reliabilities between each device illustrated in FIG. 6B and the controller 10, as will be explained in further detail below.

With reference to FIG. 6B, the controller 10 sends a data packet directly to each device 12_{D}, 12_{C}, 12_{B}, 14_{C}, 12_{J}, 12_{I}, 14_{B}, 14_{G} and 14_{F} in the system requesting a response (step 205 of FIG. 7). The controller 10 receives responses from each device 12_{D}, 12_{C}, 12_{B}, 14_{C}, 12_{J}, 12_{I}, 14_{B}, 14_{G} and 14_{F} and determines a communication reliability to each device (step 210 of FIG. 7). The controller then stores the communication reliabilities (step 215 of FIG. 7), in one example as a table such as illustrated in FIG. 6C.

A predetermined communication reliability threshold may be set by a user of the BMS system, for example, the communication reliability threshold may be set at 80%, although other communication reliability thresholds may be utilised, such as 75%, 85%, 90% etc.

At step 220, the controller 10 identifies all the devices which have a communication reliability which is greater than the communication reliability threshold (devices having a “high” reliability). For example, if the communication reliability threshold is 80%, then, with reference to FIG. 6C, the devices 12_{D}, 12_{C} and 12_{B} all have a communication reliability greater than the threshold, and therefore devices 12_{D}, 12_{C} and 12_{B} all have a “high” reliability. However, devices 14_{C}, 12_{J}, 12_{I}, 14_{B}, 14_{G} and 14_{F} all have a communication reliability which is less than the threshold (a “poor” reliability).

In order to establish reliable communications with the devices 14_{C}, 12_{J}, 12_{I}, 14_{B}, 14_{G} and 14_{F}, the controller 10 sends a communication to each “poor” reliability device (devices 14_{C}, 12_{J}, 12_{I}, 14_{B}, 14_{G} and 14_{F}) that has a communication reliability which is less than the threshold via all of the “high” reliability devices (devices 12_{D}, 12_{C} and 12_{B}) that have a communication reliability which is greater than the threshold (step 225 of FIG. 7). The “high” reliability devices (devices 12_{D}, 12_{C} and 12_{B}) are used to transfer the communication from the controller 10 to the “poor” reliability devices (devices 14_{C}, 12_{J}, 12_{I}, 14_{B}, 14_{G} and 14_{F}).

As mentioned above, in one embodiment, the controller sends 100 data packets to each “poor” reliability device in the system, via each “high” reliability device. Each “poor” reliability device then sends responses to the controller 10, the responses being transferred to the controller 10 via the same “high” reliability device which was used in order to transfer the communication (the 100 data packets) to the “poor” reliability device. The controller 10 determines the communication reliability to each of the devices 14_{C}, 12_{J}, 12_{I}, 14_{B}, 14_{G} and 14_{F} via each of the devices 12_{D}, 12_{C} and 12_{B} at step 230, and stores the communication reliabilities at step 235, in one example in a table at a storage device 17.

FIG. 6D illustrates one example of a table stored at the controller 10 indicating the communication reliabilities between the controller 10 and the devices 14_{C}, 12_{J}, 12_{I}, 14_{B}, 14₆ and 14_{F} transferred via the device 12_{D}. FIG. 6E illustrates one example of a table stored at the controller 10 indicating the communication reliabilities between the controller 10 and the devices 14_{C}, 12_{J}, 12_{I}, 14_{B}, 14_{G} and 14_{F} transferred via the device 12_{C}. FIG. 6F illustrates one example of a table stored at the controller 10 indicating the communication reliabilities between the controller 10 and the devices 14_{C}, 12_{J}, 12_{I}, 14_{B}, 14_{G} and 14_{F} transferred via the device 12_{B}.

The controller 10, at step 240, identifies all the devices which have a communication reliability (when sent via another device) which is greater than the communication reliability threshold (devices having a “high” reliability). As can be seen from FIGS. 6D to 6F, the devices 14_{C} and 12_{J} have a communication reliability which is greater than the communication reliability threshold (in one example 80%) when transferred via the device 12_{D}, the devices 12_{J} and 12_{I} have a communication reliability which is greater than the communication reliability threshold when transferred via the device 12_{C}, and the devices 12_{I} and 14_{B} have a communication reliability which is greater than the communication reliability threshold when transferred via the device 12_{C}.

However, as can be seen from FIGS. 6D to 6F, even when a communication is transferred via devices 12_{D}, 12_{C} or 12_{B} the communication reliability to devices 14_{G} and 14_{F} is still less than the communication reliability threshold. Therefore, the process of FIG. 7 returns to step 220 and the controller 10 sends a communication to each “poor” reliability device (devices 14_{G} and 14_{F}) that has a communication reliability which is less than the communication reliability threshold via all the devices which have a communication reliability, when sent via one or more other devices, which is greater than the communication reliability threshold (i.e. via device 12_{J} and device 12_{C} or 12_{D}; via device 12_{I} and device 12_{B}). In one embodiment, only wired powered devices are used to transfer communications.

The controller 10 then determines the communication reliability to each of the devices 14_{G} and 14_{F} via the one or more other devices at step 230, and stores the communication reliabilities at step 235, in one example in a table at a storage device 17.

FIG. 6G illustrates one example of a table stored at the controller 10 indicating the communication reliabilities from the controller 10 to the devices 14_{G} and 14_{F} transferred via the device 12_{J} (which is transferred via device 12_{C} or 12_{D}.). FIG. 6H illustrates one example of a table stored at the controller 10 indicating the communication reliabilities from the controller 10 to the devices 14_{G} and 14_{F} transferred via the device 12_{I} (which is transferred via device 12_{B}).

At step 245, the controller 10 determines the communication route to each of the devices in the system using the determined reliabilities which have been stored in tables 6C to 6H. For example, as can be seen from FIG. 6C, devices 12_{D}, 12_{C} and 12_{B} all have a communication reliability which is greater than the communication reliability threshold, when communicating directly with the controller 10. Therefore, the controller 10 determines that a direct route (i.e. the communication does not need to be transferred by other deceives) can be used in order to communicate with the devices 12_{D}, 12_{C} and 12_{B}.

As can be seen from FIGS. 6D to 6F, devices 14_{C}, 12_{J}, 12_{I} and 14_{B} all have a communication reliability which is greater than the communication reliability threshold, when a communication is transferred via another device. Therefore, in order to communicate with the device 14_{C} the controller 10 determines a communication route to/from device 14_{C} where communications are transferred via the device 12_{D}. In order to communicate with the device 12_{J} the controller 10 determines a communication route to/from device 12_{J} where communications can be transferred via the device 12_{D} or the device 12_{C}. In this instance, where two or more communication routes are available, which have the same communication reliability, the controller 10 may (arbitrarily) select one route over the other. In this example, device 12_{D} is selected. In order to communicate with the device 12_{I} the controller 10 determines a communication route to/from device 12_{I} where communications are transferred via the device 12_{C} or the device 12_{B}. In this instance, however, since the communication reliability via device 12_{C} is greater than the communication reliability via device 12_{B}, the controller 10 may select the route via device 12_{C}. In order to communicate with the device 14_{B} the controller 10 determines a communication route to/from device 14_{B} where communications are transferred via the device 12_{B}.

As can be seen from FIGS. 6G and 6K, the devices 14_{G} and 14_{F} have a communication reliability which is greater than the communication reliability threshold, when a communication is transferred via one or more other devices. Therefore, in order to communicate with the device 14_{G} the controller 10 determines a communication route to/from device 14_{G} where communications are transferred via the devices 12_{J} and 12_{D}, or via the devices 12_{I} and 12_{C}. In this instance, however, since the communication reliability via devices 12_{I} and 12_{C} is greater than the communication reliability via devices 12, and 12_{D}, the controller 10 may select the route via device 12_{I} and 12_{C}. Finally, in order to communicate with the device 14_{F} the controller 10 determines a communication route to/from device 14_{F} where communications are transferred via the device 12, and 12_{C}.

Once the communication routes to all of the devices of the system have been determined at step 245, the controller then sends a messages to each device of the system, at step 250, using the determined communication route and informing the device of the communication route. The controller 10 stores the communication route to each device at step 255 and each device stores the communication route to the controller 10 at step 260. The communication route to the controller may be stored in a storage device (not illustrated) at each device.

If none of the devices have a communication reliability which is greater than the communication reliability threshold, even when the communication is transferred via one or more other devices, then the communication route which has the highest reliability is selected as the communication route.

The process of FIG. 7 may be performed upon set-up of the building management system in order to determine communication routes between the BMS controller 10 and all of the wired/non-wired powered devices 12, 14 of the system. The process of FIG. 7 may also be performed periodically and/or after any new devices 12, 14 are added to the building management system. In addition the process of FIG. 7 may be performed when the narrow band frequency is changed as a result of the process of FIG. 5A, since the narrow band frequency selected may change which devices 12, 14 have/do not have a communication reliability to/from the controller 10 which is greater than the communication reliability threshold.

In one embodiment, each communication may contain (1) a network address (unique to the BMS); (2) a destination device/controller identifier; (3) a source device/controller identifier; (4) a command; and (5) a CRC checksum. In addition, each device 12 which is used to transfer a message adds its unique identifier to the message, such that the message arrives at the device/controller 10 with an audit trail. Consequently, the device/controller is able to determine the route for sending a message to the device/controller.

The non-wired powered devices 14 will not respond to communications from the controller 10 or to communications transferred via wired powered devices 12 unless they are awake. However, the non-wired powered devices 14 are asleep for most of the time. Non-wired powered devices 14, at least, wake up periodically, for example once every half an hour. When a non-wired powered device 14 wakes up the controller 10 may perform the process of FIG. 7. Consequently, the process of FIG. 7 may take a considerable period of time to perform, if the process is waiting for several non-wired powered devices 14 to wake up. Therefore, if the controller receives a communication from a non-wired powered device 14, the controller may send a response informing the non-wired powered device 14 that the process of FIG. 7 is to be performed and instructing the non-wired powered device 14 to stay awake until the process has been performed. In one embodiment, a user may manually activate each non-wired powered devices 14 so that the process of FIG. 7 can be performed.

In one embodiment, if a non-wired powered device 14 is completely out of range of the controller 10, such that its reliability is 0%, then the non-wired powered device 14 may send a broadcast request asking for any powered device 12 which are capable of communicating with the controller 10 to transfer a communication to the controller 10. Once the communication has reached the controller 10, the controller 10 can initiate the process of FIG. 7 in order to identify a communication route to the out of range non-wired powered device 14. The communication route may or may not be via the device(s) 12 which transferred the original communication, depending on the communication reliability of each device.

If a wired powered device 12 is completely out of range of the controller 10, such that its reliability is 0%, then the controller 10 can initiate the process of FIG. 7, such that a communication is transferred via one or more wired powered device 12, until the communication reaches the out of range wired powered device 12.

Returning to the BMS controller 10, as illustrated in FIG. 4, the BMS controller 10 comprises a processor 16, itself comprising agents 18. In one embodiment each agent 18 is provided with different functionality in order to control a different aspect of the building management system.

Each device 12, 14 of the system has a different function and may be a different type of device. For example, the devices 12, 14 may be devices for controlling lighting (on or off), controlling the air handling unit (to adjust temperature), etc., or the devices 12, 14 may be devices for sensing temperature, smoke, movement etc. The system abstracts all of the devices 12, 14 to create a common type of element.

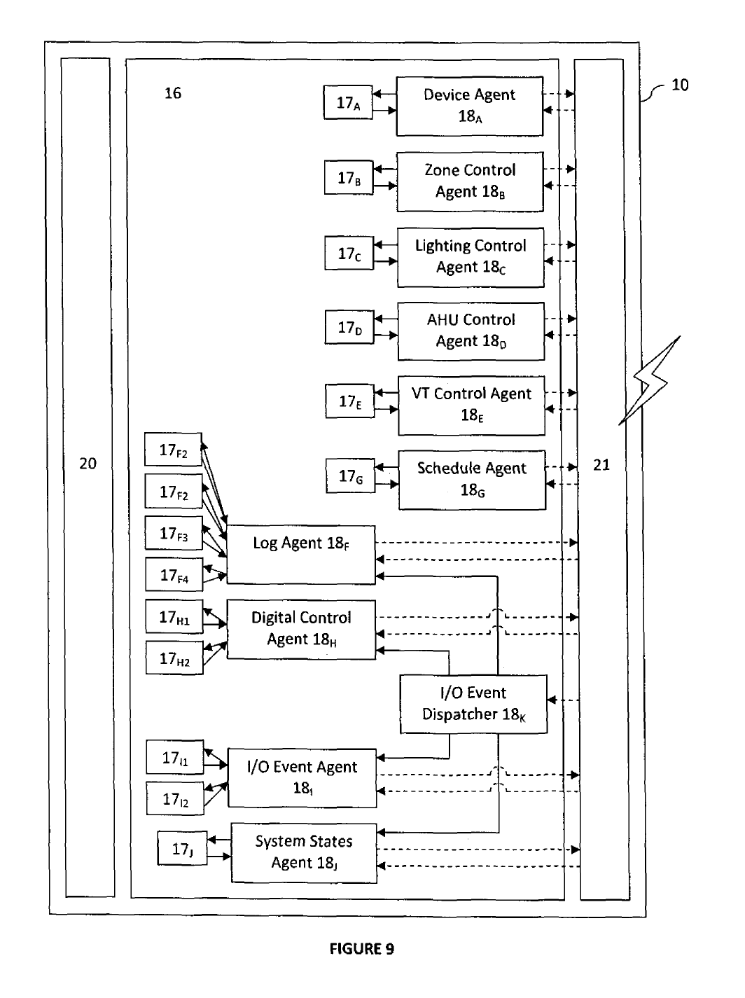

In one embodiment, illustrated in FIG. 9, the processor 16 comprises a device agent 18_{A}, a zone control agent 18_{B}, a lighting control agent 18_{C}, an air handling unit (AHU) control agent 18_{D}, a variable temperature (VT) control agent 18_{E}, a schedule agent 18_{G}, an in/out (I/O) event dispatcher 18_{K}, a log agent 18_{F}, a digital control agent 18_{H}, an in/out (I/O) event agent 18_{I}, a systems states agent 18_{J}.

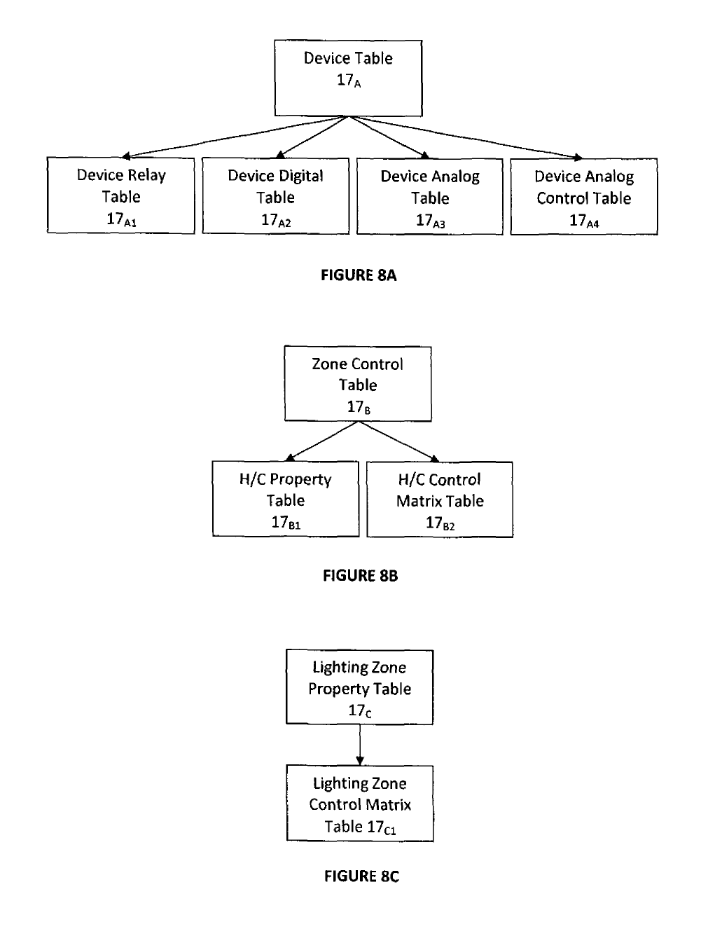

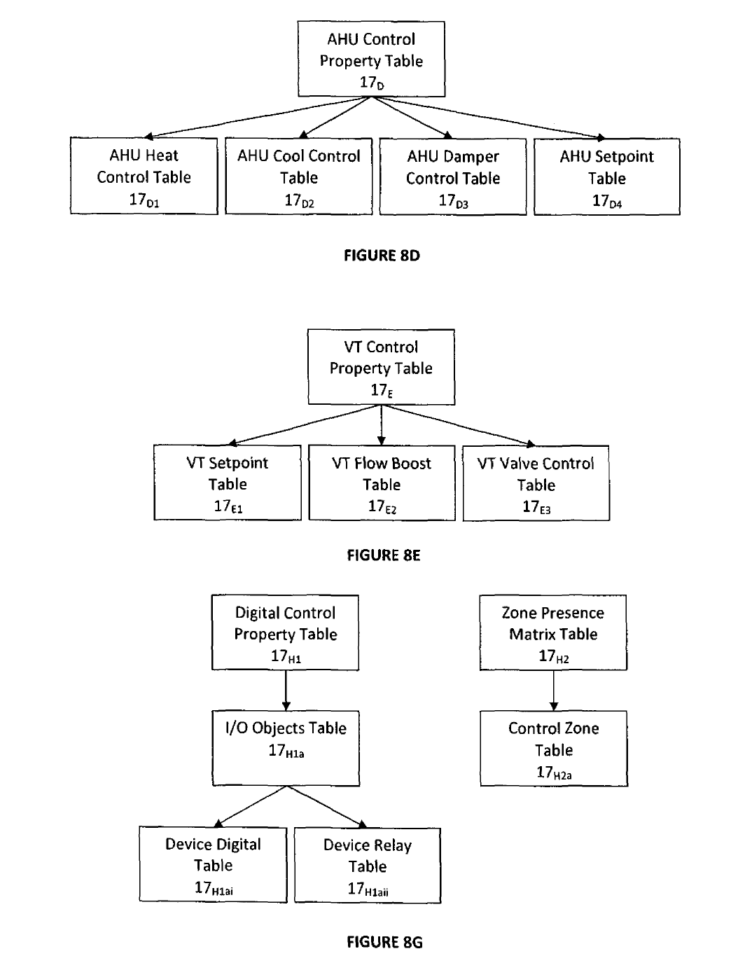

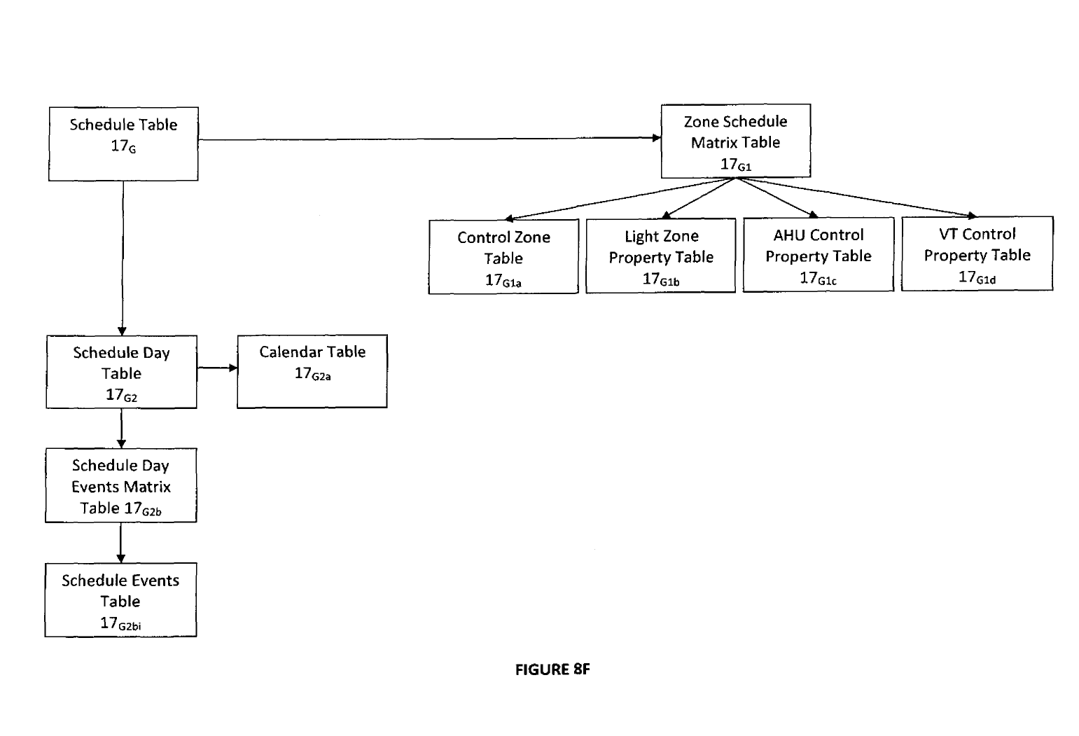

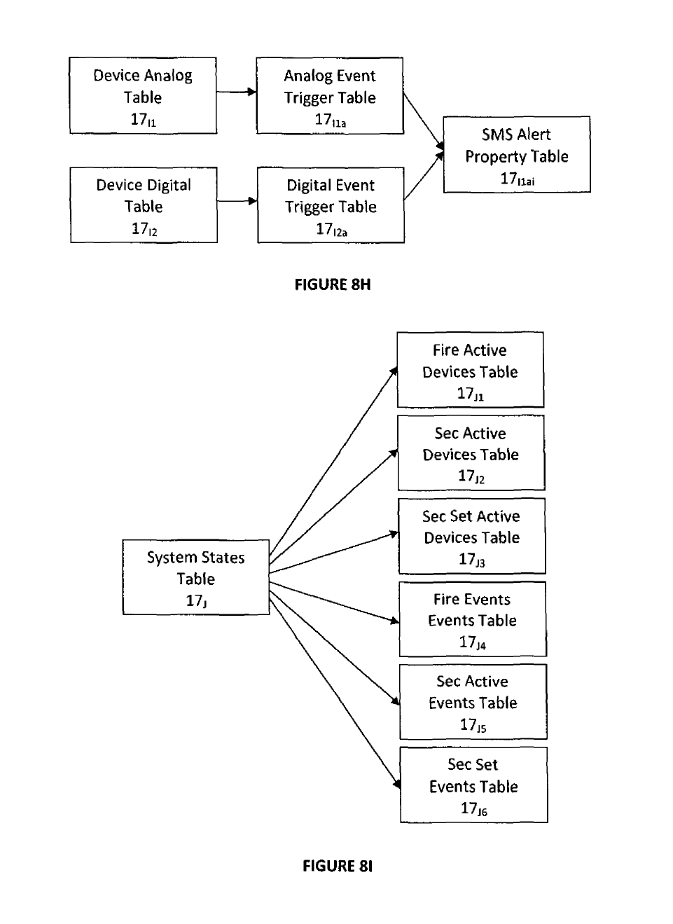

The primary functionality of the device agent 18_{A} is the bi-directional translation of wireless data packets and database tables. The device agent 18_{A} has access to a device table 17_{A} (storage device). The device table 17_{A} is illustrated in FIG. 8A and itself has access to a device relay table 17_{A1}, a device digital table 17_{A2}, a device analogue table 17_{A3} and a device analogue control table 17_{A4}. The device table 17_{A} comprises a list of devices 12, 14 in the building management system. In one embodiment, the devices are listed using their unique identifiers. Each device 12, 14 has at least one relay input/output, which is detailed in the device relay table 17_{A1}. Each device 12, 14 has at least one digital input/output, which is detailed in the device digital table 17_{A2}. Each device 12, 14 has at least one analogue input/output, which is detailed in the device analogue table 17_{A3}. Some of the devices 12, 14 may also have at least one analogue controller which is detailed in the device analogue control table 17_{A4}.

The primary functionality of the H/C zone control agent 18_{B} is to control the heating/cooling and air-conditioning zones within the building. The zone control agent 18_{B} controls on/off switches; temperature set points; an air-conditioning dead-band including presence protection and security option; and a global object state synchronisation. The zone control agent 18_{B} has access to a zone control table 17_{B} (storage device). The zone control table 17_{B} defines zones within a building. For example, each floor of a building may be defined as a separate zone, or each room, or group of rooms within a building may be defined as a separate zone in the zone control table 17_{B}. The zone control table 17_{B} is illustrated in FIG. 8B and itself has access to a H/C zone property table 17_{B1} and a H/C control matrix table 17_{B2}. The H/C zone property table 17_{B1} includes information regarding the properties of the heating/cooling systems within each zone of the building. For example, the H/C zone property table 17_{B1} may include information such as the type of H/C system(s) used in each zone (air-conditioning, wet heating etc.), define the H/C control devices and H/C sensor devices within each zone, and may specify the temperature required (set-point) within each zone. The H/C control matrix table 17_{B2} provides the linkages between everything within the zone (H/C related). For example, it defines the links between heating valves, temperature sensors etc.

The primary functionality of the lighting control agent 18_{C} is controlling the lighting zones within the building. The lighting control agent 18_{C} may control lighting on/off against photocell light sensors within the context of a time schedule. The lighting control agent 18_{C} has access to a lighting zone property table 17_{C} (storage device). The lighting zone property table 17_{C} includes information regarding the properties of the lighting system within each zone of the building. For example, the lighting zone property table 17, may include information such as the types of lighting control devices and lighting sensor devices within each zone, and may specify the when (time/day) lights are to be turned on/off. The lighting zone property table 17_{C} is illustrated in FIG. 8C and itself has access to a lighting control matrix table 17_{C1}. The lighting zone control matrix table 17_{C2} provides the linkages between everything within the zone (lighting related). For example, it defines the links between on/off switches, light sensors, motion sensors etc.

The primary functionality of the AHU control agent 18_{D} is modulating fresh air dampeners/heating and direct expansion cooling elements to achieve calculated supply air. The AHU control agent 18_{D} has access to an AHU control property table 17_{D} (storage device). The AHU control property table 17_{D} defines details of the control devices 12/sensor devices 14 which form the AHU. For example, the AHU control property table 17_{D} may include a list of heating device IDs, cooling device IDs, damper device IDS, temperature sensor IDs etc. The AHU control property table 17_{D} is illustrated in FIG. 8D and itself has access to an AHU heat control table 17_{D1}, an AHU cool control table 17_{D2}, an AHU damper control table 17_{D3} and an AHU set point table 17_{D4}. The AHU heat control table 17_{D1} includes details, for example, of how many volts are required to be applied to the heating device(s) in order to increase the temperature in the zone by a set amount. The AHU cool control table 17_{D21} includes details, for example, of how many volts are required to be applied to the cooling device(s) in order to decrease the temperature in the zone by a set amount. The AHU damper control table 17_{D3} includes details, for example, of how many volts are required to be applied to the damping device in order to increase/decrease air circulation in the zone by a set amount. The AHU set point table 17_{D4} includes details of the set point for each device. For example, with reference to the heating device, the set point table may include details such as the desired temperature of each zone, and the voltage required to be applied to achieve that temperature.

The primary functionality of the variable temperature (VT) control agent 18_{E} is to control large “wet” heating systems (radiator circuits). An outside air sensor is used to calculate the desired flow temperature into the heating circuit. The desired flow temperature will also be boosted if the desired “space” set point is not met. The VT control agent 18(has access to a VT control property table 17_{E} (storage device). The VT control property table 17_{E} defines details of the control devices 12/sensor devices 14 which form the VT system. For example, the VT control property table 17_{E} may include a list of valve IDs, temperature sensor IDs etc. The VT control property table 17_{E} is illustrated in FIG. 8E and itself has access to a VT set point table 17_{E1}, a VT flow boost table 17_{E2} and a VT valve control table 17_{E3}. The VT set point table 17_{E1} includes details of the calculated set point for each device. For example, with reference to the heating device, the set point table may include details such as the desired temperature of each zone, and the position of each valve required to achieve that temperature. The VT flow boost table 17_{E2} includes details of offsets which may be applied in order to obtain the desired set point. For example, set point table may include details such as the desired temperature of each zone, and the position of each valve required to achieve that temperature. However when each valve is provided at the position defined in the set point table, the desired temperature of each zone may not be achieved. Therefore, the VT flow boost table 17_{E2} provides offsets (in this examples, incriminations of the valve) which are to be applied in order to increase the temperature so as to reach the desired temperature. The offset to be applied may be determined based on how far away the sensed temperature is from the desired temperature. The VT valve control table 17_{E3} includes details, for example, of how many volts are required to be applied in order to adjust each valve in the zone by a set amount.

The primary functionality of the schedule agent 18_{G} is processing a 7 day schedule. It updates the properties (set points/on-off statuses) of the storage devices 17_{B}, 17_{C}, 17_{D} and 17_{E} used by the zone control agent 18_{B}, light control agent 18_{C}, AHU control agent 18_{D} and the VT control agent 18_{E} respectively. The schedule agent 18_{G} also processes the change in schedules as dictated by the holiday/trading pattern calendar.

The schedule agent 18_{G} has access to a schedule table 17_{G} (storage device). The schedule table 17_{G} is illustrated in a FIG. 8F and defines individual schedules each having a unique ID. For example there may be a weekday day schedule; a weekday night schedule; a weekend schedule; a national holiday schedule etc. The schedule table 17_{G} itself has access to a schedule day table 17_{G2}, the schedule day table 17_{G2} has access to a calendar table 17_{G2a} and details the 7 days of the week, associating dates to days, and the national holidays, identified using the calendar table 17_{G2a}. The schedule day table 17_{G2} itself has access to a schedule day events matrix table 17_{G2b}, which defines the links between events and days, for example at 6 am on a Monday the temperature set point is 16° C. and at 9 am on a Monday the temperature set point is 18° C. The schedule day events matrix table 17_{G2b} itself has access to a scheduled events table 17_{G2bi}, which details the events.

The schedule table 17_{G} also has access to a zone schedule matrix table 17_{G1}, which defines the linkages between the devices within each zone. The zone schedule matrix table 17_{G1} itself has access to a control zone table 17_{G1a}, a light zone property table 17_{G1bB}, an AHU control property table 17_{G1c} and a VT control property table 17_{G1d}. The light zone property table 17_{G1bB}, the AHU control property table 17_{G1c} and the VT control property table 17_{G1d}, may include information such as the lighting/AHU/VT control devices and sensor devices within each zone, and may specify the setpoints required within each zone.

The primary functionality of the I/O event dispatcher 18_{K} is to receive notifications of in/out events from the device agent 18_{A} i.e. relay/digital status change, temperature/light level change etc. Depending on the type of event, the I/O event dispatcher 18_{K} will execute a range of dynamic applications/agents to complete the response. The I/O event dispatcher 18_{K} is does not have access to any storage devices 17.

The primary functionality of the log agent 18_{F} is the logging of I/O events. The log agent 18_{F} inserts log entries into the individual logging tables dependent on their logging properties (i.e. analogue log hysteresis). The log agent 18_{F} is active only when launched by the in I/O event dispatcher 18_{K} (when required). The log agent 18_{F} has access to several device analogue property tables (storage device).

The primary functionality of the digital control agent 18_{H} is (1) synchronising the status of a device relay(s) dependent on the status of the device digital input that has generated the event, i.e. turn on/off a supply fan in response to an airflow digital alarm; and (2) if the device digital input is of a type “presence detect” process the presence status of any control zones, i.e. zones under control of the zone control agent 18_{B}. The digital control agent 18_{H} is active only when launched by the I/O event dispatcher 18_{K} (when required). The digital control agent 18_{H} has access to a digital control property table 17_{H1} (storage device) and a zone presence matrix table 17_{H2}. The digital control property table 17_{H1} and the zone presence matrix table 17_{H2} are illustrated in FIG. 8G. The digital control property table 17_{H1} itself has access to in/out (I/O) objects table 17_{H1a}, which has access to a device digital table 17_{H1ai} and a device relay table 17_{H1aii}. The zone presence matrix table 17_{H2} itself has access to a smart control zone table 17_{H2a}.

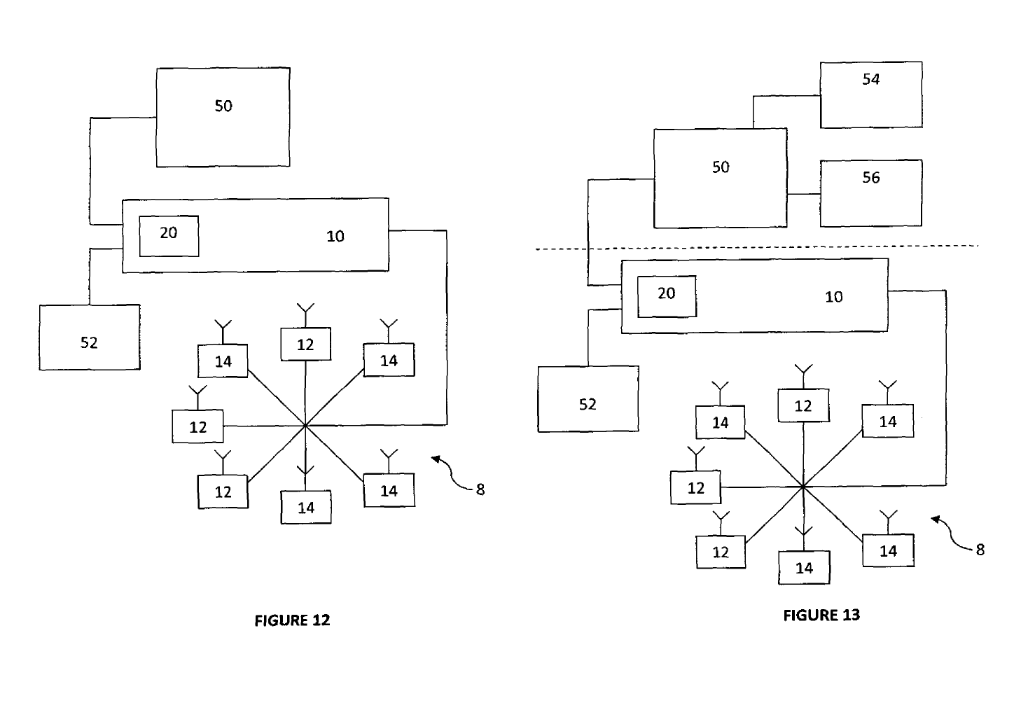

The primary functionality of the I/O event agent 18_{I} is to propagate defined in/out events (defined as alarm/alerts) to a programmer 50 (illustrated in FIGS. 12 and 13) or direct to end users via SMS messaging. These events are defined as device digital on/off or analog high temperature/low temperature alarms. The I/O event agent 18_{I} is active only when launched by the I/O event dispatcher 18_{K} (when required). The I/O event agent 18_{I} has access to a device analog table 17_{I1} (storage device) and a device digital table 17_{I2} (storage device). The device analog table 17_{I1} and the device digital table 17_{I2} are illustrated in FIG. 8H. The device analog table 17_{I1} has access to an analog event trigger table 17_{I1a} which itself has access to a SMS alert property table 17_{I1ai}. The device digital table 17_{I2} has access to a digital event trigger table 17_{I2a} which itself has access to the SMS alert property table 17_{I1ai}.

Finally, the primary functionality of the system states agent 18, is to process device digital events that are defined as devices within the system state structure. The system state structure processes inputs/outputs that provide the fire and security elements of the system. The system states agent 18_{J} is active only when launched by the in I/O event dispatcher 18_{K} (when required). The system states agent 18, has access to a system states table 17_{J1} (storage device). The system states table 17_{J} is illustrated in FIG. 8I and has access to a fire active objects table 17_{J1}, a security active objects table 17_{J12}, a security set active objects table 17_{J3}, a fire events events table 17_{J4}, a security active events table 17_{J5} and a security set events table 17_{J6}. The storage devices (tables) defined as active contain smart object elements that define the system state. The storage devices (tables) defined as events contain smart object elements that require output actions to be performed when the system state changes.

The agents 18_{A} to 18_{K} illustrated in FIG. 9 and described above, and their associated storage devices 17 are provided for illustrative purposes and a BMS controller 10 may comprise a different arrangement of agents 18, and/or different selections of agents in addition to, or instead of the agents discussed above, as required by the building management system.

The log agent 18_{F}, digital control agent 18_{H}, I/O agent 18_{I} and system states agent 18_{J} are dynamic agents, in that they are executed only for the duration it takes to execute its specific function. They are initialised by the in/out event dispatcher 18_{K} in response to events within the building management system.

The building management system also comprises an installation module (not illustrated) that may reside at the controller 10. The installation module is utilised upon initial installation of the building management system, or upon addition of a new device 12, 14 to the building management system. The installation module enables the user, who is setting up the system, or adding a device to an existing system, to easily define the interrelations between devices. The installation module comprises a storage device which contains predefined relationships, such as the technical relationship between devices, and physical relations ships. For example, the storage device may define that a heating valve must be connected to a pump and boiler, that a temperature sensor is linked to a heating valve and not a light switch etc.

Each building management system has a plurality of layers, for example, a heating layer, a lighting layer, a security layer etc, and each layer is divided into zones within each building. A zone is defined as 1 to n rooms which have been grouped together in order to form a zone. For example, a zone may be a floor of a building, or a subset of rooms within a floor of a building etc.

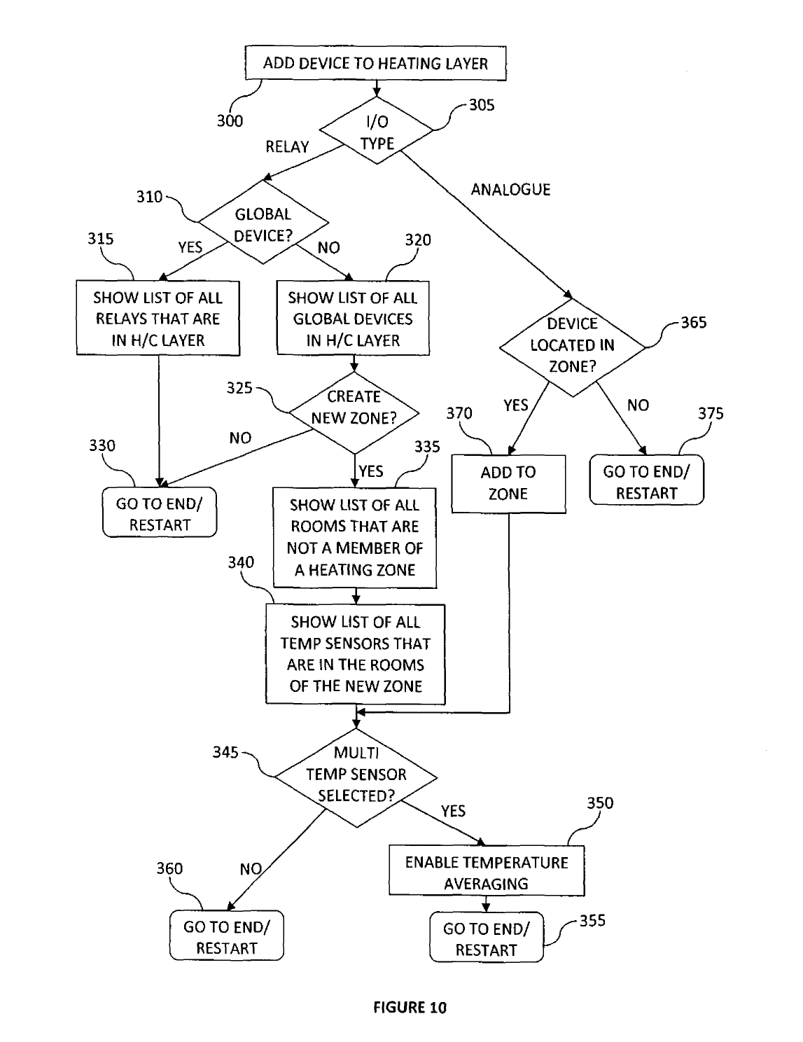

FIG. 10 illustrates schematically a process flow diagram of the steps required to add a new heating device to a heating layer of a building management system, using the installation module. Heating devices may be heating valves, pumps, boilers, temperature sensors etc. Any device which is to be turned on/off by the BMS is a relay device (controller device 12), such as heating valves, pumps, boilers. In this example, any device which is not turned on/off by the BMS is an analogue or digital device (sensor device 14), such as a temperature sensor.

The process begins at step 300, where it is determined that a new device is to be added to the heating layer of the BMS. At step 305 it is determined what type of input/output (I/O) the new device has. If the device has a relay input/output (i.e., the device is a heating valve, pump, boiler etc) then the process moves to step 310. At step 310 it is determined whether the new device is a global device. A global device is a device which is not unique to a zone within the building. For example, the boiler of the heating system is not limited to any one zone within the building, the boiler may be activated by a plurality of different valves within a building, the valves being divided into several different zones. A pump is also considered a global device, since it is not limited to a specific zone within a building.

If the new device is a global device, then the process moves to step 315. At step 315 the user is shown a list of all relay I/O devices already added to the system. The list includes other global devices. The user is required to select which, if any, of the relay devices provided within the building and already connected to the BMS, are linked with the new device. For example, if the global device is a boiler, then the list may include a pump and several different valves. The user would then select the pump and any valves which are within the specific zone of the building which are connected to the boiler. The process then moves to step 330, where the process either ends or returns to step 300.

In a heating system devices may be triggered (turned on/off) by other devices. For example, if a heating valve is turned on, this action in turn causes the pump to turn on, which in turn causes the boiler to turn on in order to heat a room. The pump and boiler may be triggered by lots of different valves provided in different zones. The valves may be triggered in response to a temperature sensor (or a group of temperature sensors if temperature averaging is being used) detecting a temperature above or below the required temperature.

If the new device is not a global device, then the process moves to step 320. At step 320 the user is shown a list of all the global devices, if any, which have already been added to the system. For example, a valve is considered a non-global device since it is specific to a particular heating zone. However, each valve is required to be linked to a pump and boiler such that adjustment of the valve results in a change in temperature within the zone. The user selects which global devices the valve is to be linked to. The process then moves to step 325, where the user is given the option of setting up a new zone within the building, in which the valve is placed. If the user does not require a new zone, then the process moves to step 330. If the user does require to create a new zone, then the process moves to step 335. At step 335, a list of all the rooms of the building, which are not part of an existing heating zone are listed. The user can create a zone by selecting one or more of the rooms. At step 340 the user is shown a list of all the temperature sensors which are already provided in the selected room(s), and the user can select to link the new device to the (all, some, or none of) the existing temperature sensors.

At step 345 it is determined if multiple temperature sensors have been selected. If there is only one temperature sensor selected then the process moves onto step 360, where the process either ends or returns to step 300. If multiple temperature sensors have been selected, then temperature averaging is activated at step 350. The process then moves onto step 355, where the process either ends or returns to step 300.

If the device has an analogue input/output (i.e., the device is a temperature sensor etc.) then the process moves to step 365. At step 365 it is determined whether the new device is located within an existing zone. If the device is not provided at a position which is part of a zone, then the process moves onto step 375, where the process either ends or returns to step 300. If the device is provided at a position which is part of a zone, then the user is provided with the option of adding the device to the zone at step 370, for example a list of existing zone may be provided. The process then moves to step 345, since addition of the new device (temperature sensor) may have resulted in the zone having multiple temperature sensors, in which case temperature averaging is enabled at step 350.

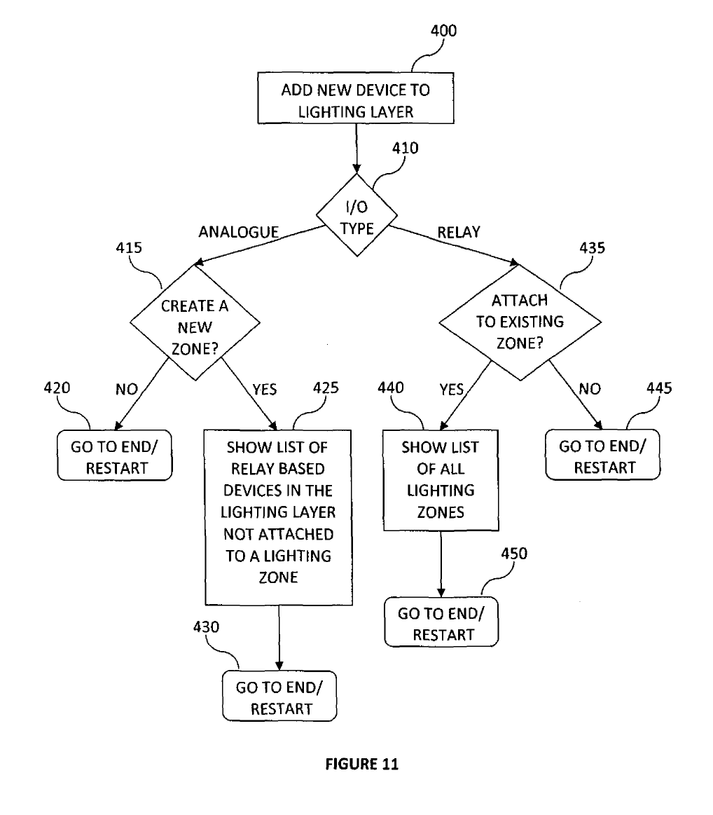

FIG. 11 illustrates schematically, a process flow diagram of the steps required to add a new lighting device to a lighting layer of a building management system, using the installation module. At step 400, a new lighting device is added to the BMS. At step 410 it is determined what type of input/output (I/O) the new device has. If the device has a relay input/output (the device is a light etc.) then the process moves to step 435. If the device has an analogue input/output (the device is a light level monitor etc.) then the process moves to step 415.

At step 415 it is determined whether the user wishes to create a new lighting zone for the light level monitor. A lighting zone consists of only one light level sensor. Therefore, if the user does not select to create a new zone, then the process moves to step 420, where the process either ends or returns to step 400. If the user selects to create a new zone, then the process moves to step 420, where the user is shown a list of all relay lighting devices in the lighting layer which are not currently attached to a lighting zone. The user can then select one or more relay lighting devices to form the lighting zone, together with the new analogue lighting device. The process then moves to step 430, where the process either ends or returns to step 400.

If the device has a relay input/output (i.e., the device is a light etc.) then the process moves to step 435. At step 435 it is determined whether the user wishes to add the new light device to an existing lighting zone. If the user does not select to add the new light device to an existing lighting zone, then the process moves to step 445, where the process either ends or returns to step 400. If the user does select to add the new light device to an existing lighting zone, then the process moves to step 440, where a list of all the existing lighting zones is displayed. The user can then select one of the existing zones. The process moves to step 445, where the process either ends or returns to step 400.

FIGS. 10 and 11 are provided for illustrative purposes to exemplify that whenever a device is added to the building management system, the installation module provides the user with a selection of choices enabling the user to quickly and easily linked various different devices provided within the same zone, can add zones and can create a building management system without requiring a vast knowledge of computer system, and without requiring a vast knowledge of lighting systems, heating systems etc. Initially upon start up, the user may be required to provide a very brief floor plan of the building, providing indications of walls within a building separating the floors into rooms. It is not necessary for the user to define features such as windows and doors etc.

FIG. 12 illustrates the BMS comprising a smart programmer 50 and a local touch screen 52, which may or may not be provided at a terminal 42. FIG. 13 illustrates BMS comprising a smart programmer 50 and a local touch screen 52, which may or may not be provided at a terminal 42. In addition, the BMS comprises a messaging server 54 and a estate management server 56. The smart programmer 50, messaging server 54 and a estate management server 56 may be provided remotely from the building which is being managed.

The estate management server 56 may be provided by a third party for analysing the data provided by the BMS in order to determine how the building(s) can be managed more efficiently.

The invention has been described with particular illustrative embodiments. It is to be understood that the invention is not limited to the above-described embodiments and that various changes and modifications may be made by those of ordinary skill in the art without departing from the scope of the invention.

1-12. (canceled)

13. A building management system comprising:
at least one device; and
a controller configured to communicate wirelessly with each of the at least one device, to determine a communication reliability for communications between the controller and each of the at least one device, and to determine a communication route between the controller and each of the at least one device in dependence on the determined communication reliabilities.

14. The building management system according to claim 1, wherein the controller sends a communication, requesting a response, to each of the at least one device and determines the communication reliability between the controller and each of the at least one device following receipt of the requested response.

15. The building management system according to claim 13, wherein the controller stores the determined communication reliabilities between the controller and each of the at least one device in a storage module.

16. The building management system according to claim 13, wherein the controller determines the communication route in dependence on determined communication reliabilities which are above a predetermined communication reliability threshold.

17. The building management system according to claim 16, wherein the controller determines if any of the communication reliabilities are below the predetermined communication reliability threshold.

18. The building management system according to claim 17, wherein if any of the communication reliabilities are below the predetermined communication reliability threshold, then the controller sends a communication, requesting a response, to each of the at least one device having a communication reliability below the predetermined communication reliability threshold via one or more device having a communication reliability above the predetermined communication reliability threshold, and the controller determines a communication reliability for communications between the controller and each of the at least one device, via the one or more device, following receipt of the requested response.

19. The building management system according to claim 18, wherein the controller stores the communication reliability for communications between the controller and each of the at least one device, via the one or more device, in a storage module.

20. The building management system according to claim 18, wherein the one or more device comprises a wired powered device.

21. The building management system according to claim 16, wherein if none of the communication reliabilities are above the communication reliability threshold, then the controller is configured to determine the communication route in dependence on the highest determined communication reliability.

22. The building management system according to claim 13, wherein the controller sends a communication to each device using the determined communication route and informing each device of the communication route.

23. The building management system according to claim 22, wherein each device stores the communication route between the controller and the device in a storage module.

24. The building management system according to claim 13, wherein the controller stores the communication route between the controller and each device in a storage module.

25. The building management system according to claim 22, wherein each device is configured to send an acknowledgement to the controller using the determined communication route.

26. The building management system according to claim 13, wherein each device comprises a unique identifier, and wherein each device is configured to attach the unique identifier to the communication before transferring the message to the controller or to another device.

27. The building management system according to claim 13, wherein each device comprises a wired powered device or a non-wired powered device.

28. The building management system according to claim 13, wherein the controller comprises:
a wireless communication module configured to enable wireless communication with each device;
a processor module configured to detect electro-magnetic interference on a plurality of frequency channels of a narrow band frequency, and select one of the plurality of frequency channels having a detected electro-magnetic interference which less than a predetermined electro-magnetic interference threshold as a communication channel for communicating with each device; and
a storage module for storing the selected communication channel.

29. The building management system according to claim 28, wherein the processor module is configured to periodically detect the electro-magnetic interference on each plurality of frequency channels, and store the periodically detected electro-magnetic interference in a second storage module.

30. The building management system according to claim 29, wherein the processor module is configured to retrieve the periodically detected electro-magnetic interference from the second storage module prior to selecting the communication channel.

31. The building management system according to claim 28, wherein the processor module is configured to detect the electro-magnetic interference on the plurality of frequency channels and select the communication channel whenever a device is added to the building management system.

32. The building management system according to claim 28, wherein if none of the plurality of frequency channels have a detected electro-magnetic interference which is less than the predetermined electro-magnetic interference threshold, then the processor module is configured to select the channel having the lowest detected electro-magnetic interference as the communication channel.

33. The building management system according to claim 28, wherein the processor module is configured to send a message to each device informing each device of the communication channel.

34. The building management system according to claim 33, wherein the processor module is configured to send a message, requesting a response, to each device using the communication channel; and
if a device does not send the requested response using the communication channel, selecting the previous communication channel and sending a message, requesting a response, to the device using the previous communication channel.

35. The building management system according to claim 28, wherein any one of the plurality of frequency channels having a detected electro-magnetic interference which is less than the predetermined electro-magnetic interference threshold may be selected as the communication channel.

36. The building management system according to claim 28, wherein a frequency channel of the plurality of frequency channels having a detected electro-magnetic interference which is lower than a detected electro-magnetic interference of the plurality of other frequency channels is selected as the communication channel.

37. The building management system according claim 28, further comprising:
a web interface module configured to enable a user to instruct the processor module to detect the electro-magnetic interference on the plurality of frequency channels, and select the communication channel.

38. The building management system according to claim 37, wherein the web interface module is configured to communicate information regarding each device to a server and to receive information from the server.

39. The building management system according to claim 28, wherein each device comprises a wired powered device or a non-wired powered device.

40-47. (canceled)

48. A method for determining a wireless communication route between at least one device and a building management system controller, the method com rising the steps of:
determining a communication reliability for communications between the controller and each of the at least one device; and
determining a communication route between the controller and each of the at least one device in dependence on the determined communication reliabilities.

49. The method according to claim 48, further comprising:
sending a communication, requesting a response, to each of the at least one device; and
determining a communication reliability following receipt of the requested response.

50. The method according to claim 48, further comprising:
storing the determined communication reliabilities in a storage module.

51. The method according to claim 48, further comprising:
determining if any of the communication reliabilities are below a predetermined communication reliability threshold.

52. The method according to claim 51, further comprising:
sending a communication, requesting a response, to each of the at least one device having a communication reliability below the predetermined communication reliability threshold via one or more device having a communication reliability above the predetermined communication reliability threshold, and
determining a communication reliability for communications between the controller and each of the at least one device, via the one or more device, following receipt of the requested response.

53. The method according to claim 52, further comprising:
storing the determined communication reliabilities for communications between the controller and each of the at least one device, via the one or more device, in a storage module.

54. The method according to claim 48, further comprising:
determining the communication route in dependence on determined communication reliabilities which are above a communication reliability threshold.

55. The method according to claim 48, further comprising:
sending a communication to each device using the determined communication route, informing each device of the communication route.

56. The method according to claim 55, further comprising:
storing at each device the communication route between the controller and the device.

57. The method according to claim 55, further comprising:
storing at the controller the communication route between the controller and the device.

58. The method according to claim 55, further comprising:
sending from each device an acknowledgement to the controller using the determined communication route.

59. The method according to claim 48 further comprising:
detecting electro-magnetic interference on a plurality of frequency channels of a narrow band frequency;
selecting one of the plurality of frequency channels having a detected electro-magnetic interference which less than a predetermined electro-magnetic interference threshold as the communication channel; and
storing the selected communication channel in a storage module.

60. The method according to claim 59, further comprising:
periodically detecting the electro-magnetic interference on the plurality of frequency channels; and
storing the periodically detected electro-magnetic interference in a second storage module.

61. The method according to claim 60, further comprising:
retrieving the periodically detected electro-magnetic interference from the second storage module prior to selecting the communication channel.

62. The method according to claim 59, further comprising:
detecting the electro-magnetic interference on the plurality of frequency channels and selecting the communication channel whenever a device is added to the building management system.

63. The method according to claim 59, further comprising:
selecting as the communication channel the channel having the lowest detected electro-magnetic interference if none of the plurality of frequency channels have a detected electro-magnetic interference which is less than the predetermined electro-magnetic interference threshold.

64. The method according to claim 59, further comprising:
sending a message to each of the at least one device informing each device of the communication channel.

65. The method according to claim 64, further comprising:
sending a message, requesting a response, to each of the at least one device using the communication channel; and
sending a message, requesting a response, to one or more of the at least one device using the previous communication channel, if the one or more of the at least one device does not send the requested response using the communication channel.

66. The method according to claim 65, further comprising:
selecting a frequency channel of the plurality of frequency channels having a detected electro-magnetic interference which is lower than a detected electro-magnetic interference of the plurality of other frequency channels as the communication channel.

67-78. (canceled)
